(19) United States
(12) Patent Application Publication
(10) Pub. No.: US 2014/0040631 A1
(43) Pub. Date: Feb. 6, 2014

(54) MEMORY CONTROLLER, NONVOLATILE MEMORY DEVICE, NONVOLATILE MEMORY SYSTEM, AND ACCESS DEVICE

(71) Applicant: Panasonic Corporation, Osaka (JP)

(72) Inventors: Hirokazu SO, Kadoma (JP); Yasuo TAKEUCHI, Tokyo (JP); Yoshihiko TAKAGI, Kanagawa Pref. (JP); Osamu SASAKI, Kanagawa Pref. (JP)

(21) Appl. No.: 13/966,439

(22) Filed: Aug. 14, 2013

Related U.S. Application Data
(63) Continuation of application No. 12/601,349, filed on Dec. 1, 2009.

(30) Foreign Application Priority Data
May 24, 2007 (JP) 2007-137649

(51) Int. Cl. G06F 21/70

(52) U.S. Cl. CPC G06F 21/70
USPC 713/189

(57) ABSTRACT

A memory device includes a memory configured to store a secret key, an interface configured to communicate with an the external apparatus in a first communication method and a second communication method that is faster than the first communication method, and a controller configured to control the memory and the interface. The controller is configured to decrypt an encrypted management data encryption key, an encrypted management data, an encrypted individual data encryption key and an encrypted individual data according to communication method, record the decrypted individual data in the memory, decrypt an encrypted application key and an encrypted application according to communication method, and record the decrypted application in the memory.

### CROSS-REFERENCE TO RELATED APPLICATIONS

This application is a continuation of U.S. patent application Ser. No. 12/601,349 filed on Dec. 1, 2009, which is a 371 of PCT/JP2008/001289 filed on May 23, 2008 and claims priority to Japanese Application No. 2007-137649 filed on May 24, 2007, which are hereby incorporated herein by reference in their entirety.

### TECHNICAL FIELD

The present invention relates to a memory controller for controlling a nonvolatile memory, a nonvolatile memory device such as a semiconductor memory card having a nonvolatile memory, a nonvolatile memory system configured by including an access device as a component in the nonvolatile memory device, and the access device.

### BACKGROUND ART

A nonvolatile memory device having a rewritable nonvolatile memory is increasingly demanded mainly for a semiconductor memory card. The semiconductor memory card is high-price compared to an optical disk, a tape medium, and the like; however, the semiconductor memory card is increasingly demanded as a recording medium for a portable apparatus such as a digital still camera and a mobile phone because of merits such as small-size, lightweight, vibration resistance, and easy handling, and in these years, the semiconductor memory card is used as a recording medium of a consumer-use moving image recording apparatus and a professional-use moving image recording apparatus for a broadcasting station. In addition, not only the portable apparatus but also a stationary apparatus such as a digital television, a DVD recorder, and like include a slot for the semiconductor memory car as standard equipment, and thus still images shot with the digital still camera can be browsed on the digital television and a moving image shot by the consumer-use moving image recording apparatus can be dubbed to a DVD recorder.

Of the nonvolatile memory devices, there is a device able to install an application for a specific purpose, and there is a card with a function for improving confidentiality by encrypting data to be stored inside and decrypting the data when the data is outputted outside or with a copyright protection function. In addition, a card able to additionally download an application after issuance has also appeared.

In such case where an application is additionally issued, the card is required to have a function for receiving data and carrying out a process of data conversion and arrangement, the process being called the installing, to allow the application to run in the card. The card includes a flash memory as a nonvolatile main memory and has a memory controller for controlling the memory, and the function of the above-mentioned process can be realized by the memory controller without mounting another chip.

Other than a method using a VM (Virtual Machine) able to control an operation of the installed application on the card and safely execute the application so as to prevent an abnormal operation, there is a method for preliminarily checking the operation of the application outside the card and installing only the application confirmed as an safe application. In the latter case, the card is not required to have a check function such as the VM and thus a cost for the function per card is advantageously reduced.

As a method for confirming the application received from the outside as an acceptable application, there is Patent document 1. In the document, an application is set to be executable in the card by giving a piece of signature data to the application (a load module) or an executable program, sending the application and the signature to the card, and verifying the validity in the card. When the technique disclosed in the document is applied, the validity of the application can be confirmed.
Patent document 1: U.S. Pat. No. 6,157,721

### DISCLOSURE OF THE INVENTION

### Problems to be Solved by the Invention

However, data to be sent to the card sometimes does not include the signature depending on a relationship between an application to be sent and a management state of the card. In addition, when the signature data has been received together with the application or after the application, the application of a larger size than that of the signature data is necessarily received even in a case where the signature data cannot be correctly decrypted, and accordingly a heavy burden is requested.

In view of the above-described problem, the present invention intends to provide a memory controller, a nonvolatile memory, and a nonvolatile memory system which are able to confirm a management state in the card before receiving the application and relief the burden requested in the signature process and the reception process of the application.

### Means to Solve the Problems

To achieve said purpose, there is provided a method of recording an application to a memory device, wherein the memory device includes a memory configured to store a secret key, and an interface configured to communicate with an external apparatus in a first communication method and a second communication method that is faster than the first communication method.

The method includes

decrypting an encrypted management data encryption key by using the secret key, when the interface receives the encrypted management data encryption key in the first communication method from the external apparatus;

decrypting an encrypted management data by using the management data encryption key, when the interface receives the encrypted management data in the first communication method from the external apparatus;

decrypting an encrypted individual data encryption key by using the secret key, when the interface receives the individual data encryption key in the first communication method from the external apparatus;

decrypting an encrypted individual data by using the individual data encryption key, when the interface receives the encrypted individual data in the second communication method from the external apparatus;

recording the decrypted individual data in the memory;

decrypting an encrypted application key by using the secret key, when the interface receives the encrypted application key in the first communication method from the external apparatus;

decrypting an encrypted application by using the application key, when the interface receives the encrypted application in the second communication method from the external apparatus; and recording the decrypted application in the memory.

In addition, there is provided a memory device.

The memory device includes

a memory configured to store a secret key;

an interface configured to communicate with an the external apparatus in a first communication method and a second communication method that is faster than the first communication method; and

a controller configured to control the memory and the interface, wherein the controller is configured to
decrypt an encrypted management data encryption key by using the secret key, when the interface receives the encrypted management data encryption key in the first communication method from the external apparatus;
decrypt an encrypted management data by using the management data encryption key, when the interface receives the encrypted management data in the first communication method from the external apparatus;
decrypt an encrypted individual data encryption key by using the secret key, when the interface receives the individual data encryption key in the first communication method from the external apparatus;
decrypt an encrypted individual data by using the individual data encryption key, when the interface receives the encrypted individual data in the second communication method from the external apparatus;
record the decrypted individual data in the memory;
decrypt an encrypted application key by using the secret key, when the interface receives the encrypted application key in the first communication method from the external apparatus;
decrypt an encrypted application by using the application key, when the interface receives the encrypted application in the second communication method from the external apparatus; and
record the decrypted application in the memory.

### EFEECTIVENESS OF THE INVENTION

The present invention is able to verify necessity of data transmission on the basis of a preliminarily-received application identifier and suppress the useless data transmission.

### BRIEF DESCRIPTION OF DRAWINGS

FIG. 1 is a relationship diagram of a server, an external apparatus, and a card.

FIG. 2 is a configuration diagram of the card.

FIG. 3 is a configuration diagram of the server, the external apparatus, and the card.

FIG. 4 is a relationship diagram of a player.

FIG. 5 shows a process flow between an application developer, a service provider, a card manufacturer, and the card.

FIG. 6 shows a process flow between a server operator and the service provider.

FIG. 7A shows a process flow 1 between the server operator, the server, the external apparatus, and the card.

FIG. 7B shows a process flow 2 between the server operator, the server, the external apparatus, and the card.

FIG. 7C shows a process flow 3 between the server operator, the server, the external apparatus, and the card.

FIG. 8 shows a piece of individual data.

FIG. 9 shows a management data format.

FIG. 10 is a relationship diagram between a data storage configuration and card version information.

FIG. 11 is a configuration diagram of the card including an area control means.

FIG. 12 shows a communication flow between the card and the external apparatus.

FIG. 13 shows a communication flow between a card having two methods and the external apparatus.

FIG. 14 shows a communication flow in updating data.

FIG. 15A shows a process flow 1 in updating data.

FIG. 15B shows a process flow 2 in updating data.

FIG. 16A shows a process flow 1 to the card having two methods.

FIG. 16B shows a process flow 2 to the card having two methods.

FIG. 16C shows a process flow 3 to the card having two methods.

FIG. 16D shows a process flow 4 to the card having two methods.

FIG. 17 is a relationship diagram between an application identifier and a management state.

FIG. 18 is a state transition diagram to the application.

### EXPLANATION FOR REFERENCE NUMERALS

100 Card
1001 Communication means
1002 Command interpretation means
1003 Memory control means
1004 Numerical value calculation means
1005 Memory means
1006 Encryption-decryption means
1007 Check means
1008 State judgment means
1009 Hash generation means
1010 Area control means
200 External apparatus
2001 Communication means
2002 Protocol conversion means
2003 Temporal memory means
300 Server
3001 Communication means
3002 Memory control means
3003 Memory means
P1 Card manufacturer
P2 Application developer
P3 Service provider
P4 Server operator
P5 User
P6 Card distributor
MO1 Manufacturer public key
M02 Manufacturer secret key
M03 Card public key
M04 Card secret key
A01 Application encryption key
A02 Application
A03 Encryption application
A04 Encryption application encryption key
A05 Signature
H01 Individual data encryption key
H02 Individual data
H03 Encryption individual data
H04 Encryption individual data encryption key
H05 Hash generated from individual data
H06 Common data
H07 Management data
H08 Management data encryption key
H09 Encrypted management data
H10 Encrypted management data encryption key
H11 Hash obtained from signature

### BEST MODE FOR CARRYING OUT THE INVENTION

### First Embodiment

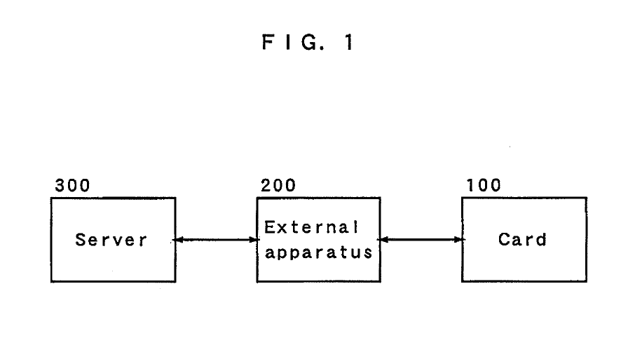

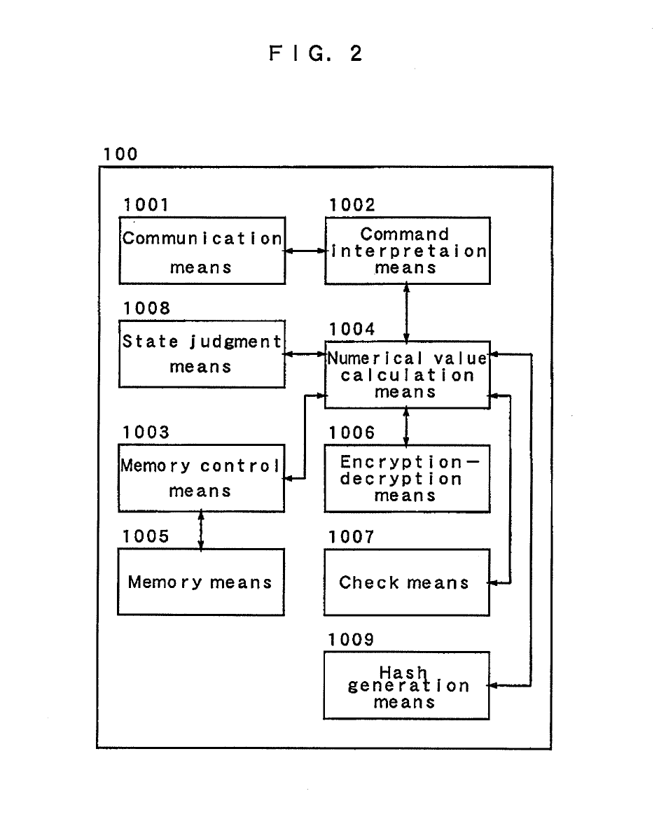

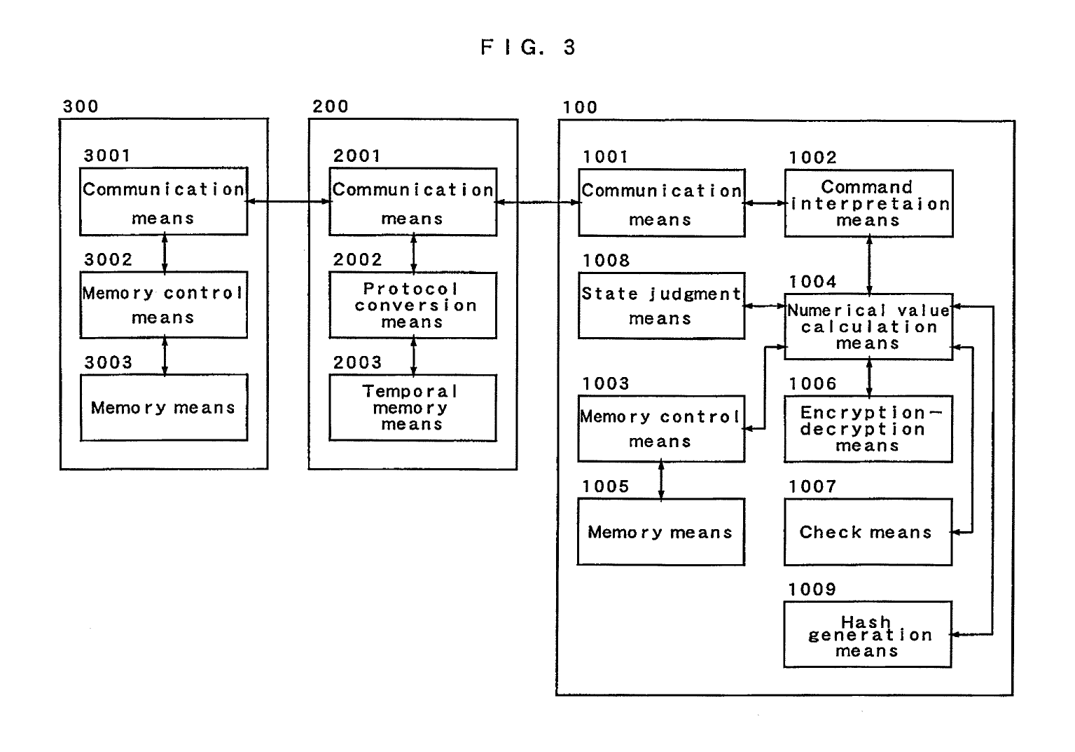

In the present embodiment, as shown in FIG. 1 and FIG. 3, a system composed of three apparatuses, a server (300), an external apparatuses (200), and a card (100) will be explained. The server (300) retains an application code that is an application entity, application data referred by the application, corresponding card information, information of other external terminals in a memory means (3003), and includes a communication means (3001) for outputting the information to outside via a memory control means (3002). Terms equivalent to the application code, and execution code for a program and the like, and an executable program will be described as an application (A02). The memory control means (3002) can receive a request from the outside via the communication means (3001), and can selectively read data in response to said request. An external apparatus (200) receives the data and the code received from the server at a communication means (2001), and passes a command to the card by using the communication means 2001 after converting the data and the code at a protocol conversion means (2002) for converting them into a command transmittable to the card. In a case where data conformed with a command specification of the card has been preliminarily received from the server (300), the external apparatus (200) directly sends only the received data to the card (100). The card (100) (refer to FIG. 2) has a command interpretation means (1002) for interpreting the received command by using the communication means (1001), and passes data to a numerical value calculation means (1004) for carrying out the data arrangement, the data conversion, and the data calculation depending on a result of the interpretation of the received command. The numerical value calculation means (1004) carries out an encryption process by using an encryption-decryption means (1006) for carrying out an encryption process and a decryption process as needed, a check means (1007) for comparing and checking the data, a hash generation means (1009) for generating a hash value of data, and a memory control means (1003) for controlling a memory means (1005). The memory means (1005) is a portion for retaining data in the card, and is accessed via the memory control means (1004). In addition, the card includes a state judgment means (1008) for judging on the basis of the application and the application identifier stored in the memory means (1005) whether or not the signature verification is necessary.

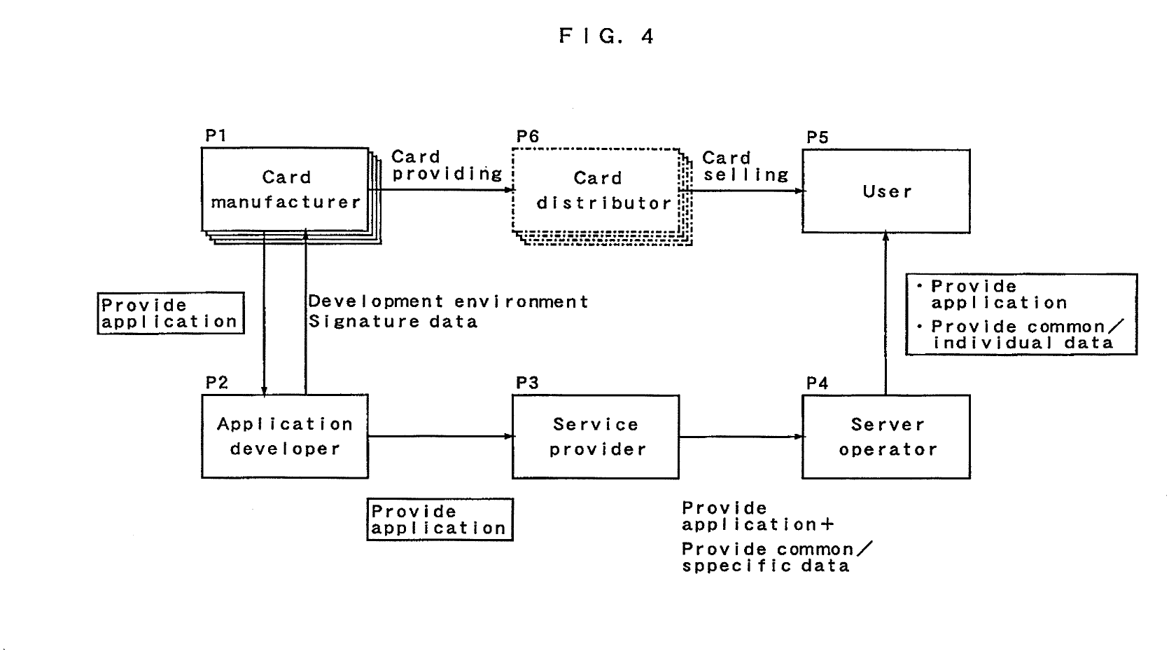

In the present embodiment, apart from the above-described system configuration, a player (P5) (hereinafter referred to as a user) who throws a trigger to request data to the card from the server by operating an external apparatus shown in FIG. 4, a player (P2) (hereinafter referred to as an application developer) who develops an application, a player (P3) (hereinafter referred to as a service provider) who provides service, a player (P4) (hereinafter referred to as a server operator) who operates a server, and a player (P1) (hereinafter referred to as a card manufacturer) who manufactures and issues a card, thus five players exist. A card distributor as a player (P6) for distributing the card (100) to a user exists in an operation of the system; however, the player is not directly related to the present invention and is accordingly omitted. Assuming that process contents to be carried out of the players are different each other in the system, the contents will be considered separately. The application developer (P2) is assumed to develop an application that can be commonly and universally distributed. Accordingly, the application can be universally provided to a plurality of service providers for providing service, and the service provider (P3) can customize the application by introducing information specific to the service such as identification information or key information. The service provider (P3) is assumed to provide the actual service by customizing the above-mentioned application. The server operator (P4) is assumed to operate a general web server for outputting data in response to the request from the external apparatus (200). The card manufacturer (P1) carries out from the manufacture of the card; the setting of data required for the card; and the validation of the card usable in the market, and is assumed to lend a development environment to the application developer (P2) and gives a signature to the application. The player model considered here is only one example, and a case where one player plays roles of several players or a case where a process of one player is subdivided more are included in the scope of the present invention. For example, there may be a case where the card manufacturer (P1) carries out only the manufacture of the card and another player carries out the validation of the card, the lending of development environment, and the signature of application, and a case where the card distributor whose explanation is omitted in the above description carries out the validation of the card and a case where the card manufacturer receives data created by the service provider and sets the data to the card are also assumed. In addition, a case where the service provider (P3) or the application developer (P2) plays a role of the application developer (P2) is also considered.

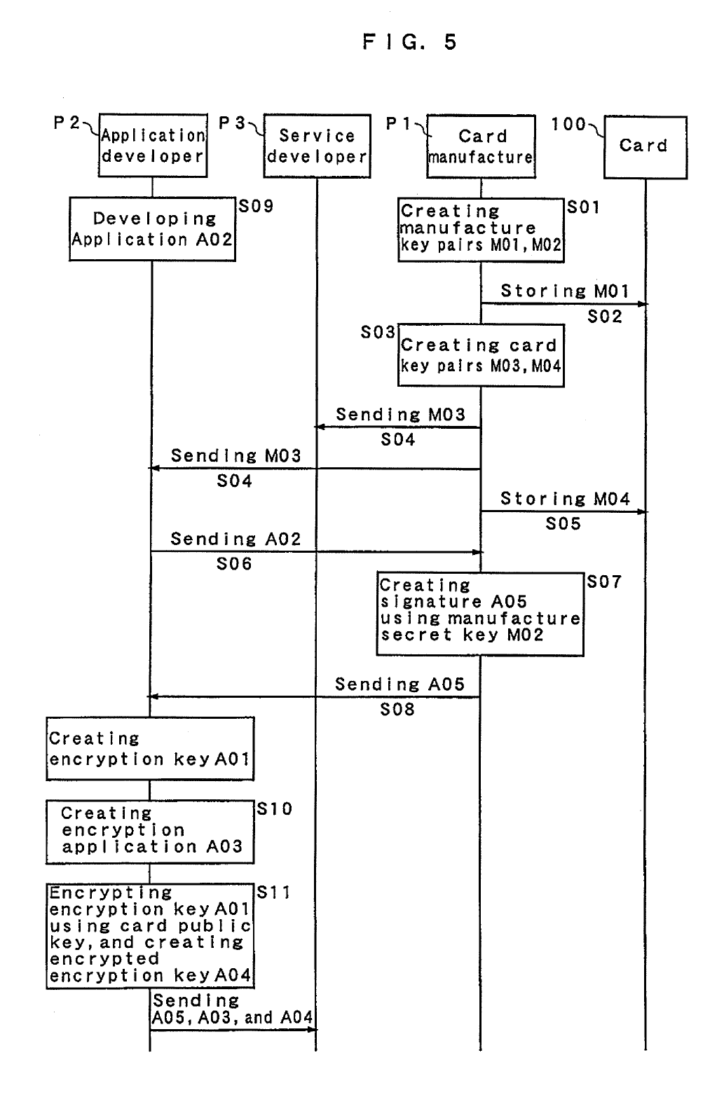

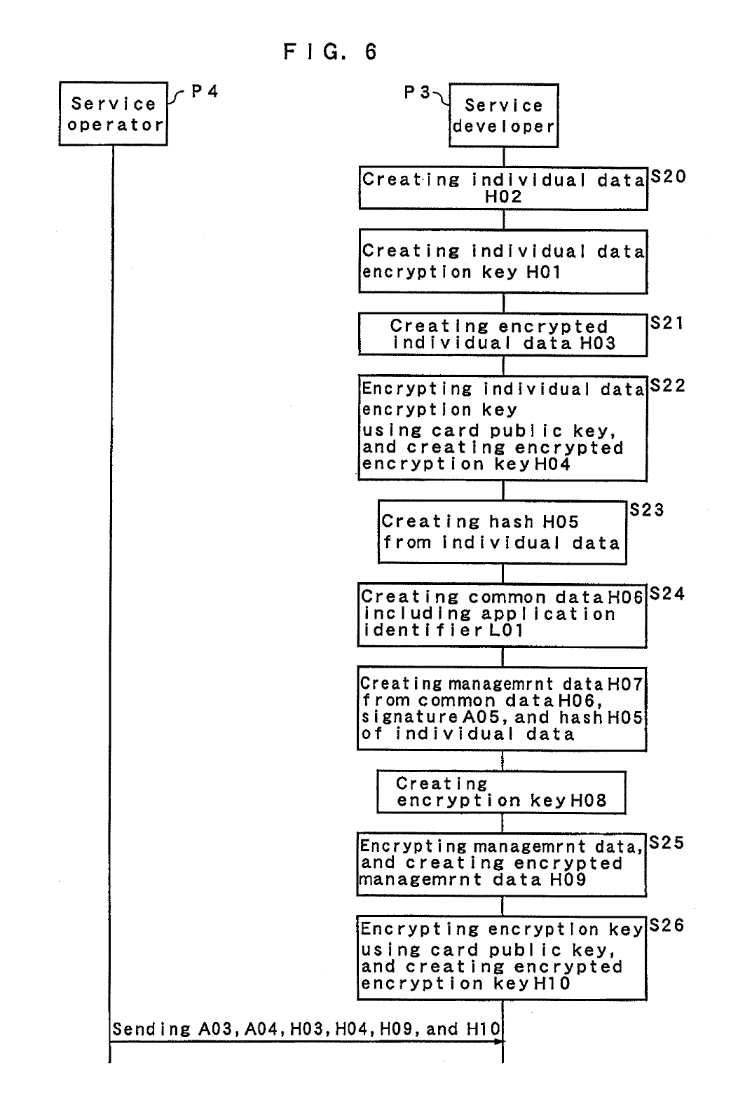

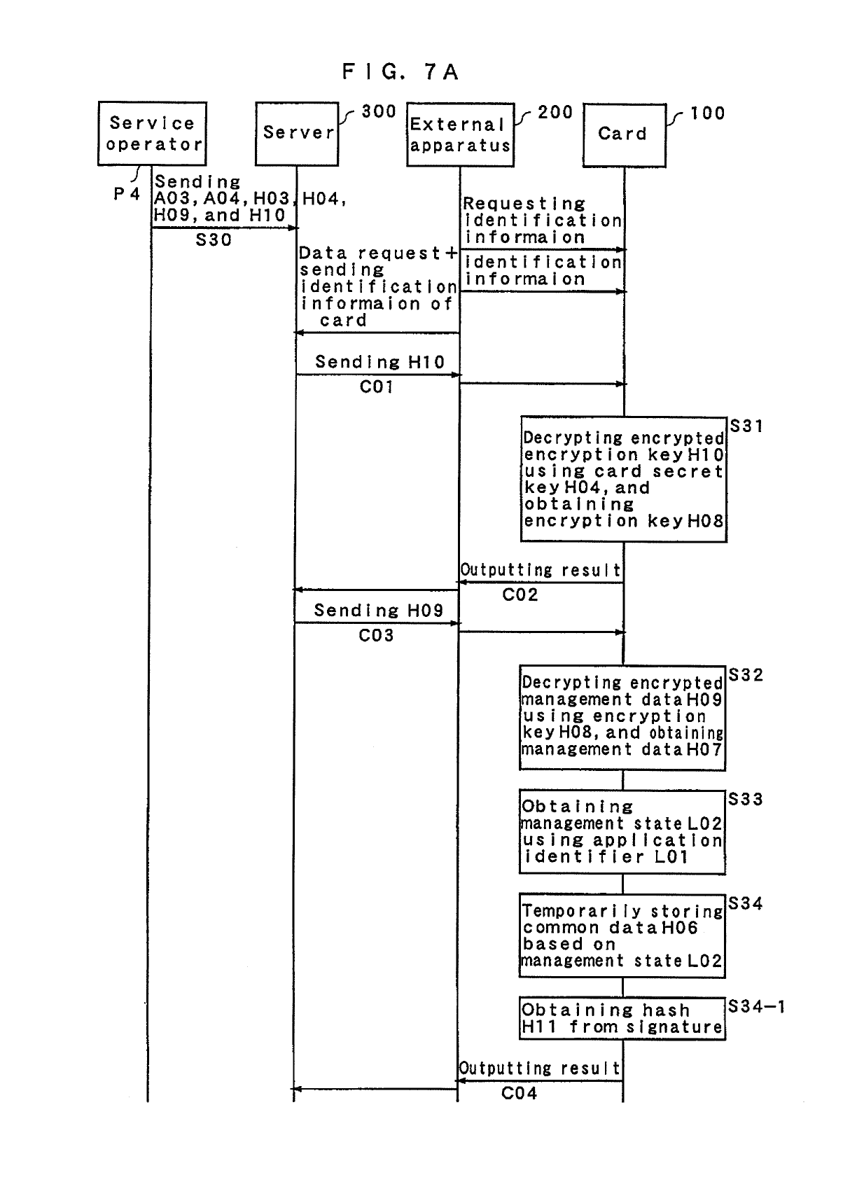

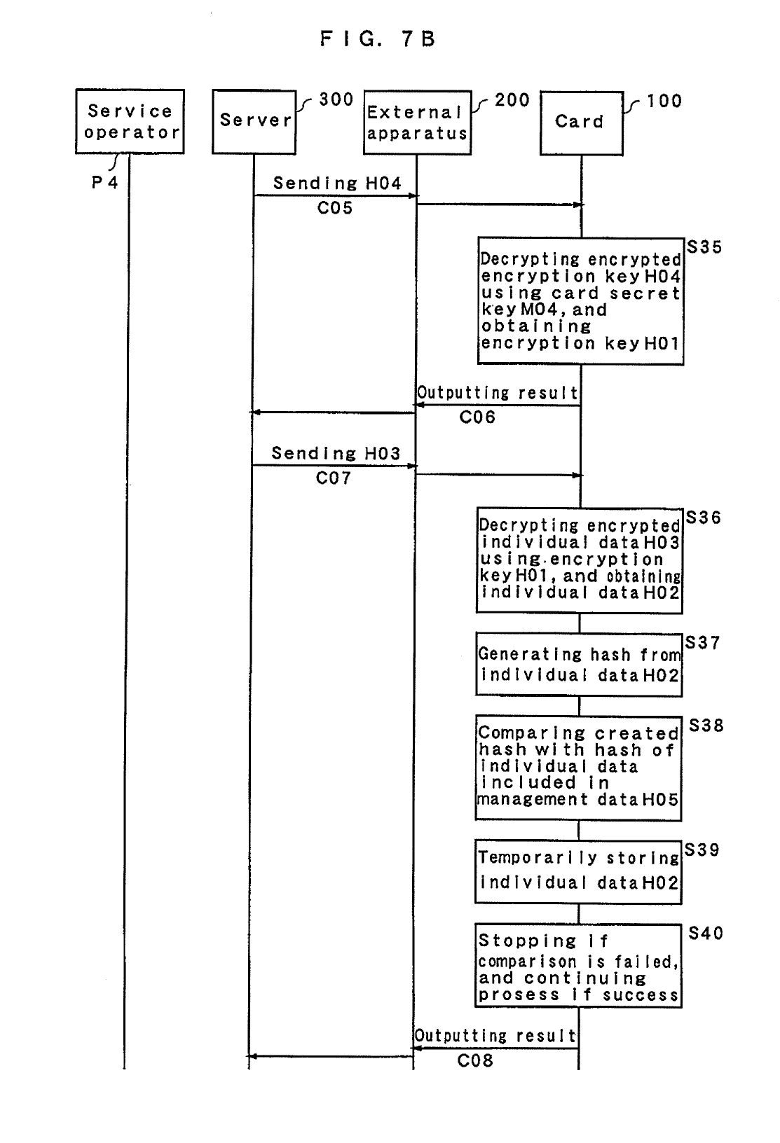

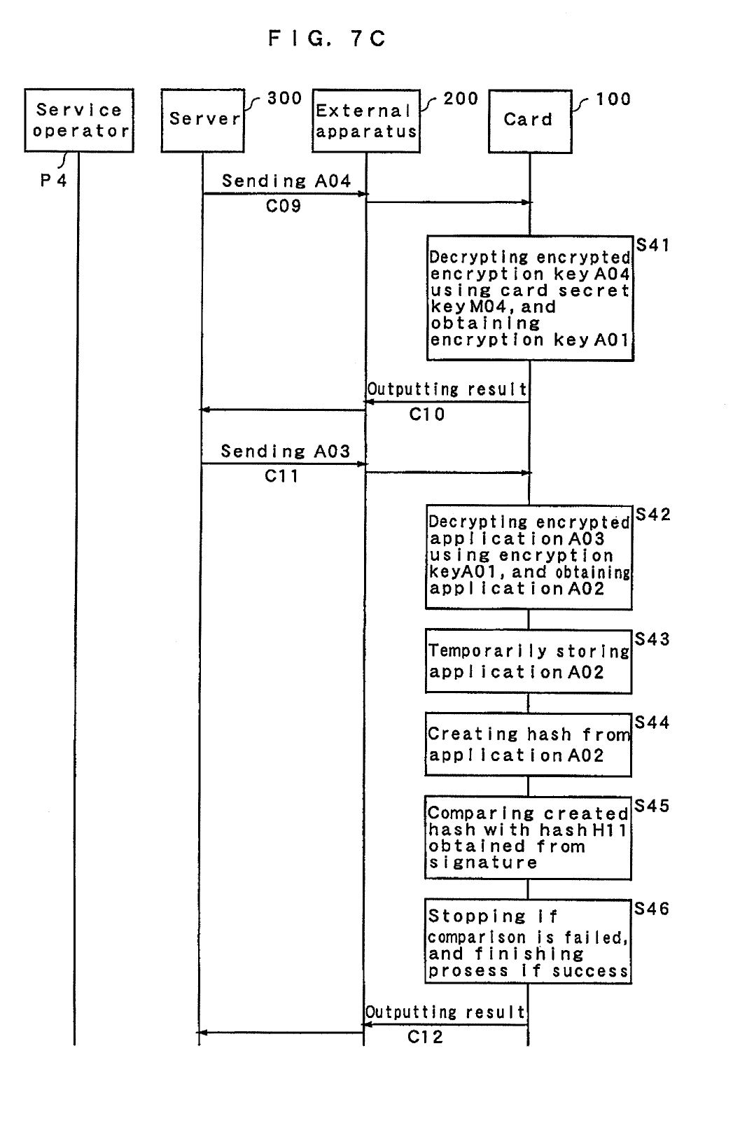

Next, referring to FIG. 5, FIG. 6, FIG. 7A, FIG. 7B, and FIG. 7C, the processes carried out by the respective players will be explained. At first, the card manufacturer (P1) preliminarily creates an RSA key pair of the card manufacturer (S01). Then, of the produced keys, an RSA public key (M01) of the manufacturer is set to the card (S02). A secret key (M02) symmetrical to the public key is used when a signature is given to the application produced by the application developer. In addition, an RSA key pair stored in the card to be manufactured is preliminarily created (S03). Of the created keys, an RSA public key (M03) of the card is distributed to the application developer and the service provider (S04). An RSA secret key (M04) of the card is stored in the card (S05). Meanwhile, the keys (M01, M02, M03, and M04) created by the card manufactures are not limited to the RSA key, and other public key cryptosystems such as the elliptic curve cryptosystem, the DH key delivery system, and the ElGamal cryptosystem may be used. In addition, the length of RSA key also is not limited to 1024 bits and 2048 bits, and may be freely changed in line with a security policy in a card operation.

The signature is carried out on the basis of a petition by the application developer (sending of the application (A02)). The card manufacturer confirms an operation of the given application, creates hash data of the given application and carries out a padding process if no problem, creates a signature by using the RSA secret key of the card manufacturer to the data (S07). The created signature (A05) is provided to the application developer (S08). Meanwhile, depending on a security policy of the card manufacturer, the signature is sometimes entrusted to the application developer or the service provider. In the case, the card manufacturer provides the RSA secret key (M02) used for the giving of signature, or creates a certificate with respect to a newly created public key pair or the public key pair created by the application developer or the service provider by using the RSA secret key (M02). When the certificate is sent to the card and the card can confirm validity of the certificate, the card can use the public key temporarily described in the certificate in a signature verification process in stead of the RSA public key (M01).

The application developer (P2) preliminarily receives a development environment corresponding to the card (100) and the public key (M03) of the card from the card manufacturer (P1). The application developer develops an application corresponding to the card by using the development environment (S09). The finished application (A02) is sent to the card manufacturer (P1) (S06), and is given the signature (A05) (S08). The application developer transfers the created application to the service provider (P3), and specifically the application developer encrypts and passes the application at that time. The reason the application is encrypted is that only the application developer can carry out the development by using the development environment provided by the card manufacturer and accordingly it results in a leak of secret information that the service provider can view the application developed by using the environment. In a case where the secret information is leaked when shared striding over a player, it becomes ambiguous which player caused the leak and it can be considered at worst that the division of roles cannot be realized. In response to this, in the present embodiment, the application developer firstly encrypts the application (A02) with an originally created key (A01) (hereinafter referred to as an application encryption key), and thus creates an encrypted application (A03) (S10). In addition, the developer encrypts the application encryption key (A01) with the preliminarily distributed public key (M03) of the card, and thus creates an encrypted key (A04) (S11). The encrypted application (A03), the encrypted key (A04), and the signature (A05) of the application are transferred to the service provider (P3). The service provider (P3) cannot decrypt both of two pieces of the encrypted data (A03 and A04).

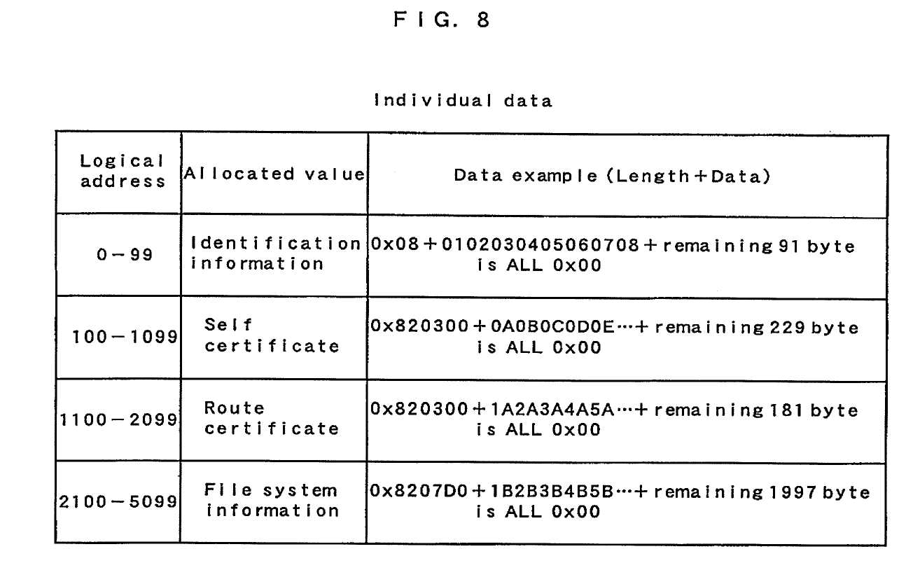

The service provider (P3) creates data (hereinafter referred to as individual data) used for individually customizing the application received from the application developer (P2) (S20 in FIG. 6). Meanwhile, because of dependency on an operation policy of the service, it is not considered, for example, whether all data to be created are changed in each of the applications or some data of the data is shared. In a case of creating the individual data (H02), the service provider (P3) needs to separately receive an external specification of the application from the application developer (P2). As an example, the external specification is configured so that the application refers to first 100 bytes as identification information, next 1000 bytes as self certificate data, subsequent next 1000 bytes as route certificate data, and subsequent 3000 bytes as file system information (refer to FIG. 8). Information indicating a length of data is set at the starting position, and extent of the area to be referred by the application as valid data is shown.

Similar to the application developer (P2), the service provider (P3) encrypts the created individual data (H02) by using a originally created key (H01) (hereinafter referred to as an individual data encryption key) (S21). Then, the service provider creates the encrypted individual data (H03), encrypts the individual data encryption key (H01) by using the public key of the card (M03) preliminarily distributed from the card manufacturer (P1) (S22), and creates the encrypted individual data encryption key (H04) (S23). On this occasion, the service provider creates the hash (H05) to the created individual data (H02) (S23).

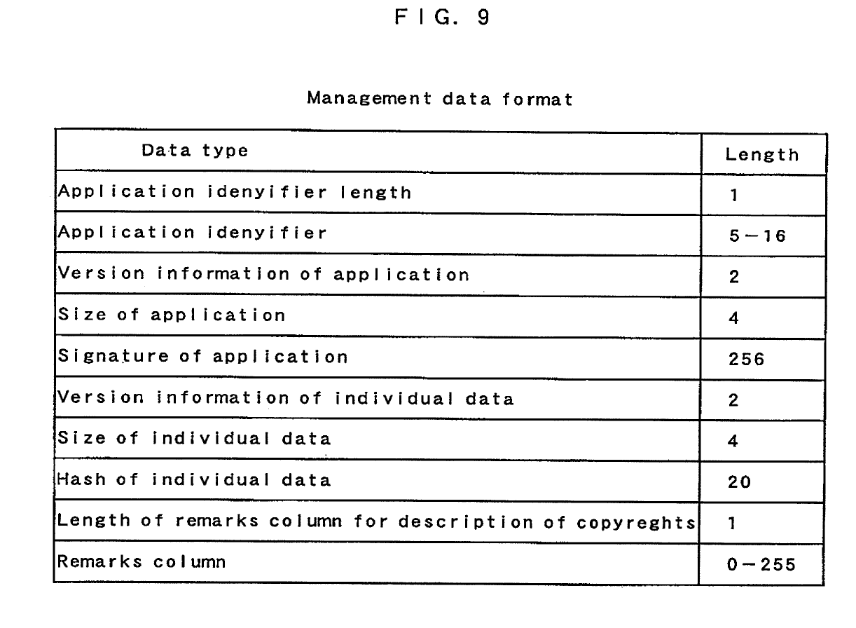

The service provider (P3) manages together the created hash (H05), the signature (A05) received from the application developer, and additional application management information such as the identification information used for identifying an application and copyright information and service provider information each created (S24) by the service provider (P3) (hereinafter refereed to as common data (H06)). Hereinafter, they are referred to as management data (H07). FIG. 9 describes an example of a format of the management data (H07). The service provider (P3) encrypts the management data (H07) by using a originally created key (hereinafter referred to as a management data encryption key (H08)), creates the encrypted management data (H09) (S25), encrypts the management data encryption key (H08) by using the public key of the card (M03) preliminarily distributed from the card manufacturer (P1), and creates the encrypted management data encryption key (H10) (S26).

Since being created and managed by the service provider himself, the individual data encryption key (H01) and the management data encryption key (H08) may be prepared together or separately. In the case of separate preparation, a management effort becomes complex but security measures in leakage of key is tightly secured, and accordingly the present embodiment will describe the case of separate preparation.

The service provider (P3) distributes data (A04) made by encrypting the encrypted application (A03) received from the application provider (P2) and the application 20 encryption key, data (H04) made by encrypting the encrypted individual data (H03) and the individual data encryption key, and data (H10) made by encrypting the encrypted management data (H09) and the management data encryption key (H08) to the server operator (P4) (S27). The server operator (P4) cannot decrypt all of the received encrypted data (A03, A04, H03, H04, H09, and H10).

In the present embodiment, an encryption algorithm used for three keys, the application encryption key (A01), the individual data encryption key (H01), and the management data encryption key (H08), is regarded as a common key encryption method. Here, the common key is selected in view of: time required for encryption and decryption of data; and a key length, a specification limited to the common key is not necessary, and a public key encryption method may be used. Meanwhile, the present embodiment uses the AES of the common key encryption method; however, the embodiment is not limited to the method and well-known common key encryption method such as the DES, T-DES, MISTY, Camellia, and RC6 may be used. In addition, if the card can accept other methods, common key encryption methods published in future also can be accepted.

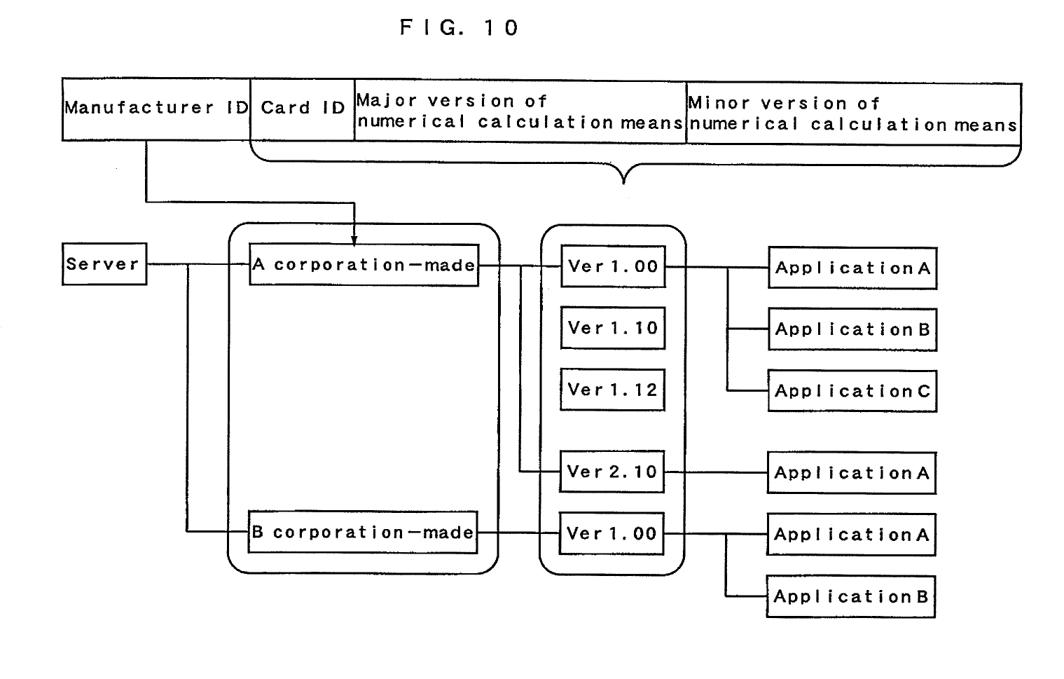

The server operator (P4) registers the received data (A03), (A04), (H03), (H04), (H09), (H10) in the memory means (3003) of the server (300) (S30 in FIG. 7A). In the registration, it is required to know the data received from the service provider (P3) corresponds to which card and which version. Said information is the identification information of the card, and is information to be obtained from the card (100) by the external apparatus (200) and to be sent to the server together when the external apparatus requests data to the server (300). The server (300) needs to preliminarily know plural pieces of encryption data corresponding to said identification information in order to send the data to the external apparatus, and the data is information separately informed from the service provider or the application developer. FIG. 10 shows the version information outputted by the card and an example of data management form on the server corresponding to the information. A command is prescribed so that the card can output said identification information, and response data corresponding to the command is notified to the external apparatus. The command is sent and received in negotiation regulated by an application loaded in the card or in a communication layer. Meanwhile, in a case of handling only a piece of card of one version, information of type and version of the card are not required.

An order of transmission of data by the server (300) in response to the data request from the external apparatus (200) is from the management data encryption key, the common data, the individual data encryption key, the individual data, the application encryption key, to the application. Meanwhile, since said order is for saving data amount temporarily retained in the card as much as possible and for subsequent processing, the order is not limited to this if a sufficient temporal memory area exists in the card.

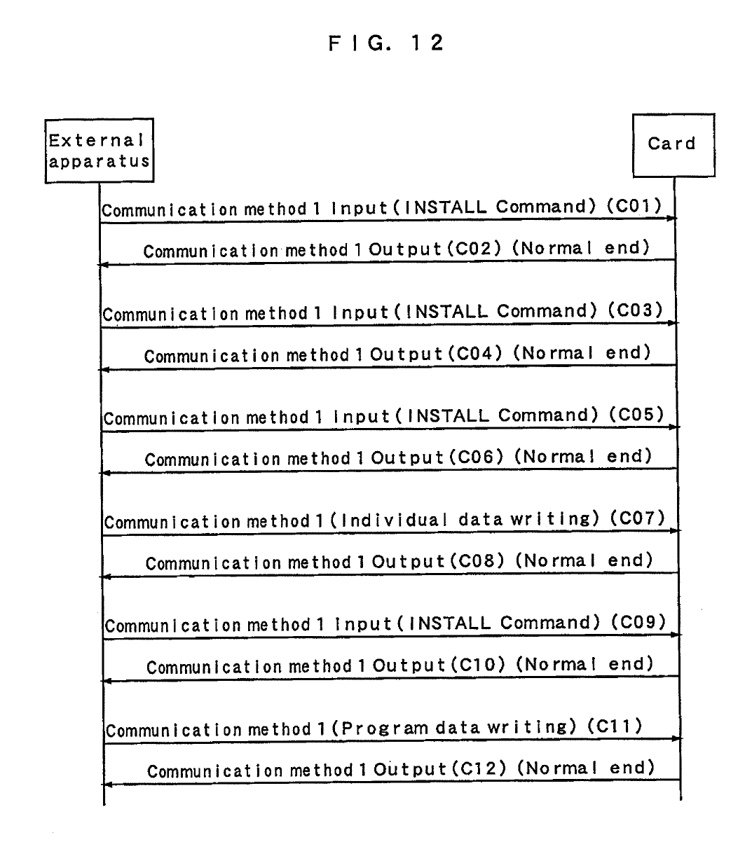

FIG. 12 shows a communication flow between the card (100) and the external apparatus (200). At first, the communication means (1001) receives data (H10) made by encrypting the management data encryption key via the external apparatus (200), and passes the data to the command interpretation means (1002). The command interpretation means (1002) checks a command added to said data, and interprets what the command shows and a purpose of the usage. In the present embodiment, the following operation will be described assuming the content of the command is installation of an application to the card. The command interpretation means (1002) notifies the numerical value calculation means (1004) that the command requests installation of an application, and passes data to the numerical value calculation means. The numerical value calculation means (1004) obtains the card RSA secret key (M04) retained by the memory means (1005) via the memory control means (1003), and decrypts the received data by the encryption-decryption means (1006) (S31). The numerical value calculation means (1004) retains the decrypted management data encryption key (H08) in the memory means (1005) via the memory control means (1003). When there is no problem in said process, a code indicating a normal end is outputted to the external apparatus (200) (C02).

Next, the communication means (1001) receives the encrypted management data (H09) via the external apparatus (C03). The numerical value calculation means (1004) decrypts the management data (H09) encrypted in the encryption-decryption means (1006) by using said management data encryption key (H08) (S32). Since the decrypted management data (H07) conforms with the preliminarily prescribed format (FIG. 9), the numerical value calculation means (1004) reads data in accordance with said format. The application identifier (L01) for identifying an application existing in the common data (H06) included in the management data (H07) is used to read a management state (L02) stored in the memory means (1005) in the card. The application identifier (L01) and the management state (L02) of the application are managed in pairs.

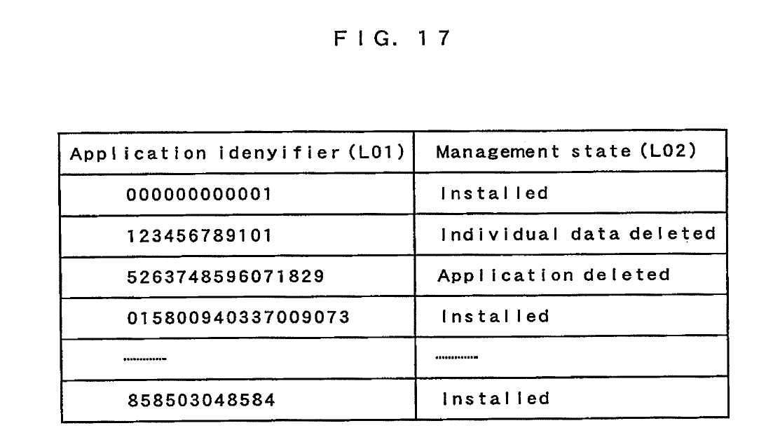

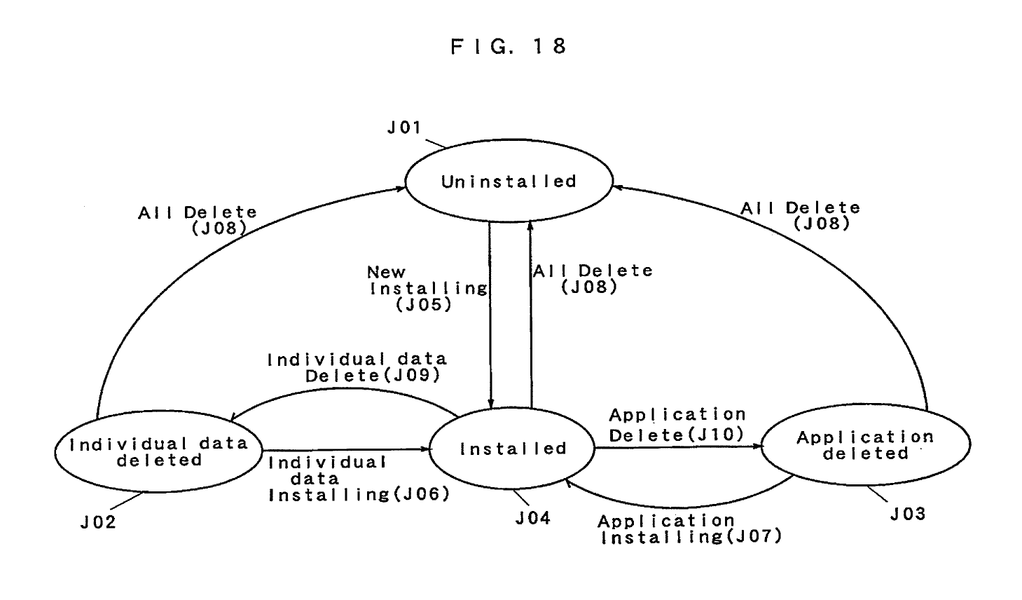

As the management state (L02), an installed state (J04) where both of the application (A02) and the individual data (H02) are installed, an individual data deleted state (J02) where only the application is installed, and an application deleted state (J03) where only the individual data is installed, and four states can be known from the management state (L02) including a state (J01) where no application and no data are installed. FIG. 17 shows a correspondence table of the application identifier (L01) and the management state (L02). In addition, the respective management states can be transited by an external operation (FIG. 18). When the installation process (J05) normally completes from the no-installation state (J01), the state turns into the installed state (J04). When an individual data delete process (J09) is carried out in the installed state (J04), the state turns into the individual data deleted state (J02). When an application delete process (J10) is carried out in the installed state (J04), the state turns into the application deleted state (J03). In addition, when the process (J06) for installing only individual data is carried out in the individual data deleted state (J02), the state returns to the installed state (J04). When the process (J07) for installing only an application is carried out in the application deleted state (J03), the state also returns to the installed state (J04). When an all delete process (J08) is carried out in each state (J02, J03, and J04), the state becomes an uninstalled state (J01). In this case, there is no problem even if the application identifier once installed is managed as said uninstalled state without being deleted and even if the application identifier and its state are deleted together from the correspondence table of FIG. 17. For this reason, in a case where a target application identifier is not in the memory means or in a case where the state is in the uninstalled state (J01) regardless of existence of the application identifier, the application will be regarded as an uninstalled application.

The card obtains the management state (L02) by using the application identifier (L01) (S33). Data required in the received management data varies depending on the management state (L02). Specifically, in the uninstalled state (J01), all of the management data is required, but in the individual data deleted state (J02), only the hash (H05) of the individual data in the management data (H07) is required. In the application deleted state (J03), only the signature (A05) in the management data (H07) is required. When unnecessary data is included in the management data, the data is ignored and the process is not carried out. Thus, there is no problem if the data to be ignored is not sent at the time of first sending. On the contrary, when necessary data is not included, the process turns into an error. In that case, the numerical value calculation means (1004) outputs not a normal end but an error code indicating the process finished because of an abnormality of the format in outputting (C04) a result to the external apparatus (200). If no problem, the memory means (1005) temporarily stores data in the common data (H06) required depending on the management state (L02) via the memory control means (1003) (S34). Meanwhile, the process is not limited to the above-mentioned error, and when an abnormal operation has been caused, a code preliminarily-determined with the outside indicating the fact is outputted. In the present embodiment, the state is in the uninstalled state (J01), all of the management data is required.

Based on the state, when the signature (A05) is essential data, the signature is preliminarily decrypted. The numerical value calculation means (1004) decrypts the signature (A05) in the encryption-decryption means (1006) by using the public key (M01) of the manufacturer. The numerical value calculation means (1004) confirms whether or not an adequate padding process is carried out to the decrypted data. In the case where the padding process has been confirmed to be adequate, a target hash (H11) is obtained because it has been confirmed at least the signature is created by an adequate secret key (S34-1).

In the case where the adequate padding has not been confirmed, the process turns into an error. If there is no problem, the external terminal (200) is notified that the process is normal (C04). Since the process can be efficiently carried out, it is preferable not only to notify the normal end but also notify the external terminal (200) of necessity of subsequently sending the individual data.

By decrypting the signature before sending the application, an error can be checked before the application (A02) having a larger size than that of the signature is sent, and communication that will be wasteful in the error can be eliminated. In addition, in a case where the signature data is made by 2048-bit RSA, the signature data size is 256 bytes, but in a case of using the SHA-1 to the hash, the decrypted hash data has 20 bytes by itself, and accordingly a memory required in the card can be saved if only the hash is taken out.

Next, the communication means (1001) receives the data (H04) made by encrypting the individual data encryption key via the external apparatus (200) (C05 in FIG. 7B), and passes the data to the numerical value calculation means (1004). The numerical value calculation means (1004) decrypts the data in the encryption-decryption means (1006) by using the RSA secret key (M04) retained in the memory means (1005) (S35). The memory means (1005) in the card retains the decrypted individual data encryption key (H01). Next, the communication means (1001) receives the encrypted individual data (H03) via the external apparatus (200) (C07). The communication means (1001) passes said data to the numerical value calculation means (1004). The numerical value calculation means (1004) decrypts the encrypted individual data in the encryption-decryption means (1006) by using said individual data encryption key (H03) (S36). Contents of the individual data (H02) are interpreted by the application (A02) mentioned below, and the card does not need to interpret the contents. The numerical value calculation means (1004) generates a hash of the decrypted individual data (H02) in the hash generation means (1009) (S37), and confirms whether or not the hash is the same as the hash (H05) of the individual data included in the management data by using the check means (1007) (S38). If they are identical, the numerical value calculation means (1004) temporarily stores the individual data in the memory means (1005) via the memory control means (1003) (S39). If not identical, the numerical value calculation means (1004) stops the installation process (S40). When outputting a result to the external apparatus (C08), the numerical value calculation means (1004) outputs an error code indicating not a normal end but that the hash is not identical. If no problem, the card notifies the external terminal (200) that the process is normal (C08). Since the process can be efficiently carried out, it is preferable not only to notify the normal end but also notify the external terminal (200) of necessity of subsequently sending the application (A02).

Next, the communication means (1001) receives the data (A04) made by encrypting the application encryption key via the external apparatus (200) (C09 in FIG. 7C), and passes the data to the numerical value calculation means (1004). The numerical value calculation means (1004) decrypts the data in the encryption-decryption means (1006) by using the RSA secret key (M04) retained in the memory means (1005) (S41). The memory means (1005) in the card retains the decrypted application encryption key (A01). Next, the communication means (1001) receives the encrypted application (A03) via the external apparatus (200) (C11). The communication means (1001) passes said data to the numerical value calculation means (1004). The numerical value calculation means (1004) decrypts the encrypted application in the encryption-decryption means (1006) by using said application encryption key (A01) (S42). Since it is supposed that an operation of the application has been preliminarily confirmed by the manufacturer, the card does not need to newly verify the operation of said application. The numerical value calculation means (1004) temporarily stores the application in the memory means (1005) via the memory control means (1003) (S43). The card generates the hash of the decrypted application (A02) in the hash generation means (1009) (S44). The check means (1007) compares a hash (H11) obtained from the signature with said generated hash of the application (S45). If they are identical, the numerical value calculation means (1004) stores the application (A02) in the memory means (1005). If not identical, the numerical value calculation means (1004) stops the installation process (S46). When outputting a result to the external apparatus (200) (C10), the numerical value calculation means (1004) outputs an error code indicating not a normal end but that the signature is not identical. If identical, the numerical value calculation means (1004) confirms that all data is normal, and finishes the installation process. When the signature is proper, the numerical value calculation means (1004) judges the hash of the individual data and the common data encrypted together with the signature, and sets the common data related to the application, the individual data, and the application to be operable in the card and changes the state into the installed state (J04). Specifically, the numerical value calculation means (1004) operates so as to confirm said management state (L02) from the memory means via the memory control means (1003) in response to a request from the external apparatus (200), to call an application when the installed state (J04) where the application is operable is shown, and to pass a command sent from the command interpretation means (1002) to the application.

The nonvolatile memory device of the present invention is able to select necessary data from sent data by managing the application identifier (L01) and the management state (L02). Accordingly, the installation process can be efficiently carried out because not all processes are equally carried out but only a necessary process is carried out.

Due to the selection, consumption of a resource in the card can be suppressed at minimum and a process time can be minimized.

In addition, since the signature (A05) can be obtained and processed based on the management state (L02), it can be known whether or not data to be signed may be preliminarily sent, and since the card notifies the information of the external apparatus (200), the external apparatus (200) does not send unnecessary data to the card, and accordingly wasteful communication can be omitted.

Next, a procedure of updating the above-mentioned data will be explained. Since the server and the card have no method for preventing the impersonation each other in a case where the two-way authentication is not carried out, the server cannot manage which card has installed an application and the card cannot know which service provider provided the installed application. For this reason, in a case of updating an application on the card, the card cannot confirm whether or not the application is distributed from the same service provider. For this reason, the application can be installed again after being deleted once; however, relevance with the first application cannot be proved in the updating, and accordingly there is a problem that an update process for changing only a data processing part by remaining a part of data in the card cannot be realized. Then, a method for when the application installed by using the above-mentioned installation method is updated, verifying without an external authentication whether or not the update is for the application from the proper service provider to realizing the update process will be described.

As described above, there are three types of data, the management data, the individual data, and the application. The management data necessarily exists to store data related to the individual data and the application, but there is a case where only the individual data or the application is updated.

In the case of updating only the individual data, the hash (H05) of the individual data and the application identifier (L01) to be updated are stored in the common data (H06), encrypted in the management data, and then sent together with the encrypted individual data. In the case of updating only the application, the signature of the application and the application identifier (L01) to be updated are stored in the common data (H06), encrypted in the management data, and then sent together with the encrypted application.

As described above, the nonvolatile memory device of the present invention does not include the signature (A05) in the case of updating only the individual data, and the card cannot prove the reliability. Accordingly, the memory device saves the individual data encryption key together for the updating in the first installation, and carries out decryption by using the individual data encryption key preliminarily retained in the card in the updating without decrypting a key from the key data encrypted with the public key. Based on the fact that the individual data encryption key known by only the service provider can be used and the hash of the decrypted data is the same as the hash sent in the management data, it can be known that the provider is the service provider (P3) of the first installation or a substitute service provider having the pursuant information. By using the method, a player able to carry out the update is limited to only the service provider of the first installation only in the card without carrying out the external authentication by the card and without carrying out the application management by the server.

Regarding the application, by using the above-mentioned method, the update process can be limited only to the application developer (P2) of the first installation. Since the signature (A05) is added to the application, the application itself cannot be falsified; however, relevance with the individual data (H02) cannot be found in the updating, and accordingly the individual data of another application can be referenced replacing only the part of the application with respect to an application having another individual data that is already installed in the card. For this reason, it is important to limit a player who carries out the updating by using the above-mentioned measure.

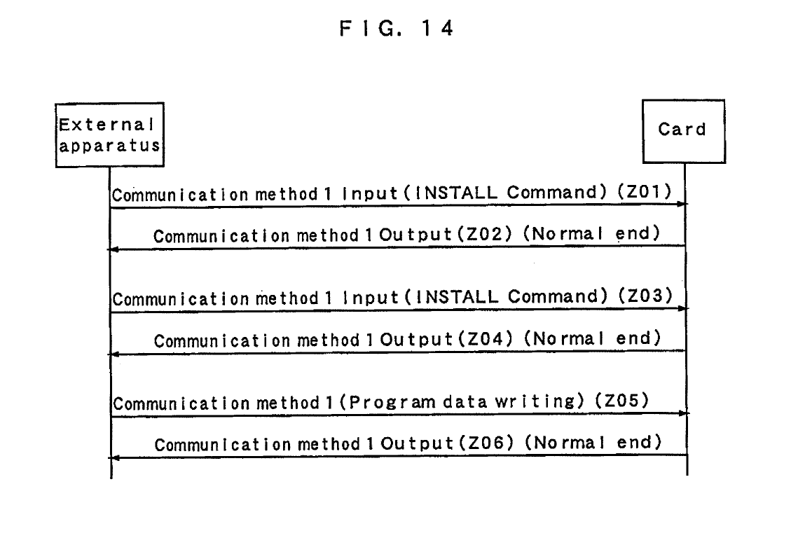

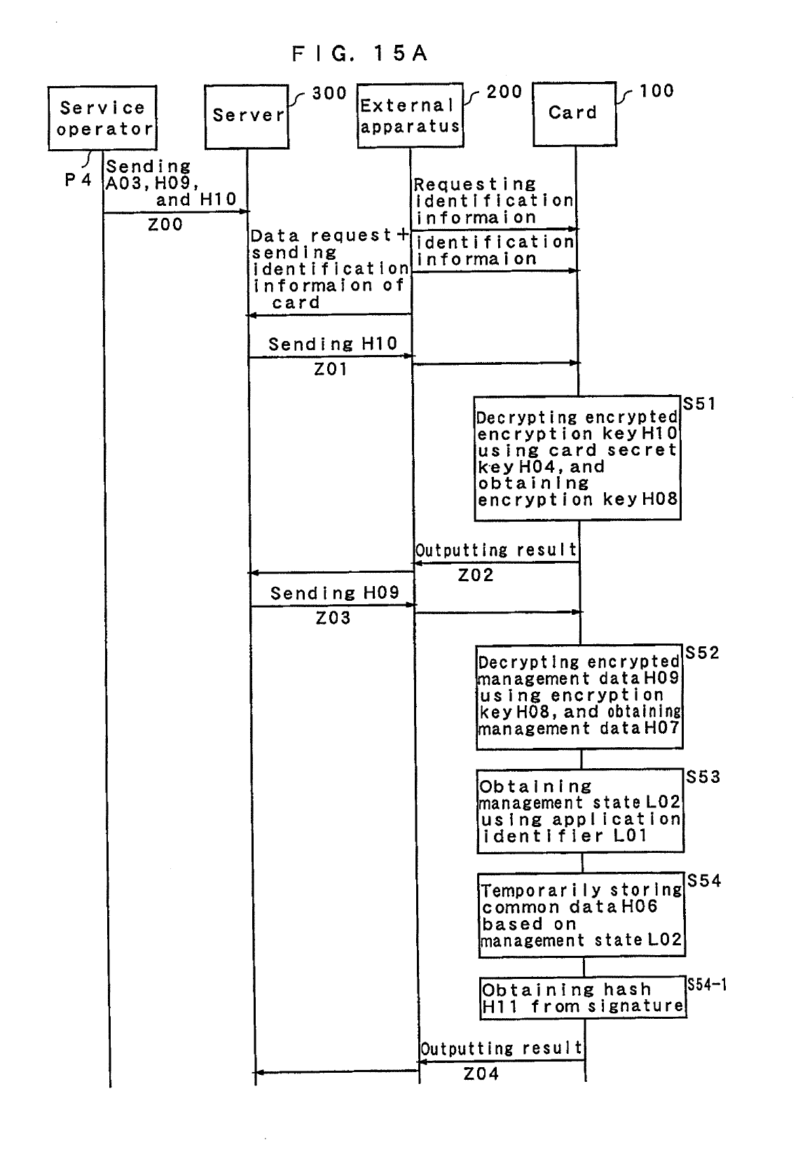

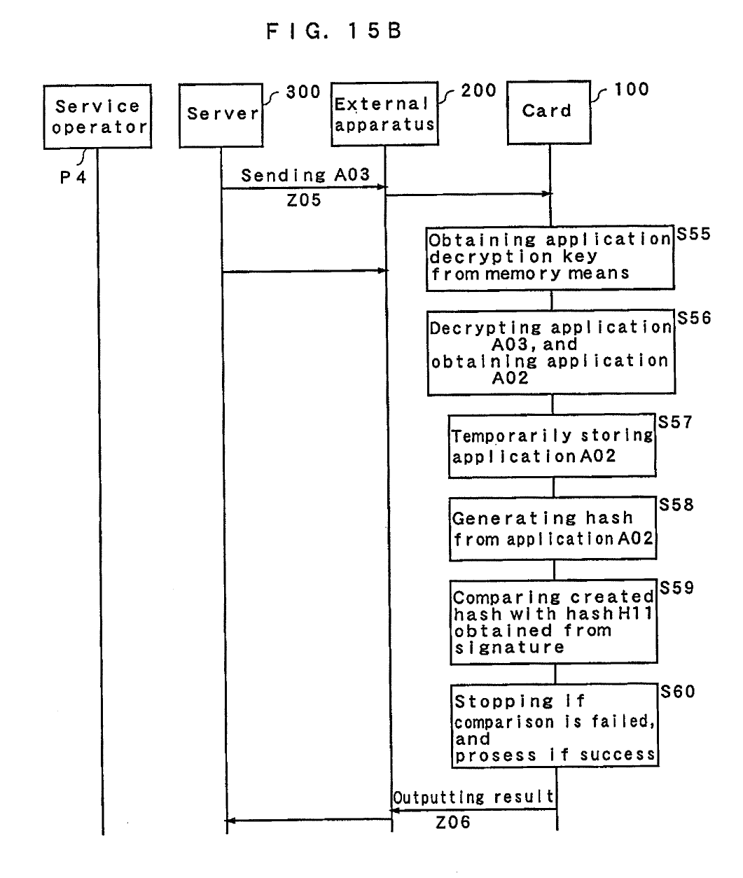

FIG. 14 shows a communication flow between the card (100) and the external apparatus (200), and referring to FIG. 15A and FIG. 15B, process flows carried out by the respective players will be explained. Since the application developer develops an application again, the application is delivered to the server operator (P04) via the service provider, the server operator compares a portion in which the encrypted application is registered with data preparation in new installation, and the different point is that the service provider does not generate the individual data and does not include the hash of the individual data in the management data, the flow will be omitted.

The server operator registers the encrypted application (A03) delivered from the service provider, the encrypted management data (H09), and the encrypted encryption key (H10) as an application for update in the server (ZOO). In order to respond to a request from the external apparatus, the version information and the explanation is added to the application for update so that the application can be expressly found. Or, in a case where an update request from the external apparatus preliminarily includes some information, the server (300) distributes an application corresponding to said information. On this occasion, said information sent from the external apparatus (200) are, the identification information of application, the version information of a present application stored in the card, and the card identification information.

At first, the communication means (1001) receives the data (H10) made by encrypting the management data encryption key via the external apparatus (200) (Z01), and passes the data to the command interpretation means (1002). The command interpretation means (1002) checks a command added to said data, and interprets what the command shows and a purpose of the usage. The following operation will be described assuming a content of the command is the update process of the application. Methods of distinguishing an update operation are, a method where the command interpretation means confirms whether or not the operation is the update process and a method where the card processes the operation as an installation process at first and automatically recognizes a next process as the update process by confirming a state of the application corresponding to an identifier of the application. In the present embodiment, a case of carrying out the interpretation based on a command to determine a content of process will be described.

The command interpretation means (1002) notifies the numerical value calculation means (1004) that the command orders the update process of the application, and passes the received data. The numerical value calculation means (1004) obtains the RSA secret key (M04) retained by the memory means (1005) via the memory control means (1003), and decrypts the received data in the encryption-decryption means (1006). The numerical value calculation means (1004) retains the decrypted management data encryption key (H08) in the memory means (1005) via the memory control means (1003) (S51). When there is no problem in said process, a code indicating a normal end is outputted to the external apparatus (200) (Z02).

Next, the communication means (1001) receives the encrypted management data (H09) via the external apparatus (Z03). The numerical value calculation means (1004) decrypts the management data (H09) encrypted in the encryption-decryption means (1006) by using the above-mentioned management data encryption key (H08) (S52). Since the decrypted management data (H07) conforms with the preliminarily prescribed format (FIG. 9), the numerical value calculation means (1004) reads data in accordance with said format. In the case of the updating, all data are not necessarily embedded, and it is enough to include only information necessary for the updating. Since the present embodiment describes the updating of application, the version information of the individual data, a size of the individual data, the hash of the individual data need not be described, and an application identifier length, the application identifier (L01), the version information of the application, an application size, and the signature of application (A05) are essential. The information used for identify an application is used for checking whether or not the application to be updated exists in the card (S53). In addition, it is confirmed whether or not the application to be updated retains an updatable state on the basis of the correspondence table (FIG. 17) of the application identifier and the management state (L02), the table being retained in the memory means. In a case where there is no identifier having the same value, the process is regarded as an installation process because no data is registered; however, the data to be sent needs to include data necessary for a new installation process.

In a case where the state is already in the installed state (J04), the numerical value calculation means stops the installation process. When outputting a result to the external apparatus (Z04), the numerical value calculation means outputs an error code indicating not a normal end but that the application is already installed. If in the application deleted state (J03), the common data is temporarily stored in the memory means (1005) via the memory control means (1003) (S54).

Since the signature (A05) is essential data in the application delete state (J03), the signature is preliminarily decrypted. The numerical value calculation means (1004) decrypts the signature (A05) in the encryption-decryption means (1006) by using the public key (M01) of the manufacturer. The numerical value calculation means (1004) confirms whether or not an adequate padding process is carried out to the decrypted data. In the case where the padding process has been confirmed to be adequate, a target hash (H11) is obtained because it has been confirmed at least the signature is created by an adequate secret key (S54-1).

Meanwhile, the process is not limited to the above-mentioned error, and when an abnormal operation has been caused, a code preliminarily-determined with the outside indicating the fact is outputted. If there is no problem, the external terminal (200) is notified that the process is normal (Z04). Since the process can be efficiently carried out, it is preferable not only to notify the normal end but also notify the external terminal (200) of necessity of subsequently sending the individual data.

Next, the communication means (1001) receives the encrypted application (A03) via the external apparatus (200) (Z05 in FIG. 15B). The communication means (1001) passes said data to the numerical value calculation means (1004). The numerical value calculation means (1004) obtains the application encryption key (A01) used for decrypting data in the first storage of data from the memory means (1005) on the basis of the application identifier (L01) to be updated and information showing that the management state is in the application deleted state (J03) (S55). The encryption-decryption means (1006) decrypts the encrypted application by using said application encryption key (A01) (S56). Since it is supposed that an operation of the application has been preliminarily confirmed by the manufacturer, the card does not need to newly verify the operation of said application. The numerical value calculation means (1004) temporarily stores the application in the memory means (1005) via the memory control means (1003) (S57). The card generates the hash of the decrypted application (A02) in the hash generation means (1009) (S58). The check means (1007) compares the hash (H11) obtained from the signature with said generated hash of the application (S59). If they are identical, the numerical value calculation means (1004) stores the application in the memory means (1005). If not identical, the numerical value calculation means (1004) stops the installation process (S60). When outputting a result to the external apparatus (200) (Z06), the numerical value calculation means (1004) outputs an error code indicating not a normal end but that the signature is not identical. If identical, the numerical value calculation means (1004) confirms that all data is normal, and finishes the installation process. When the signature is proper, the numerical value calculation means (1004) judges the common data encrypted together with the signature as proper data, and in addition to the already-installed individual data, changes the common data related to the application and the application into the installed state (J04) where the data are operable in the card.

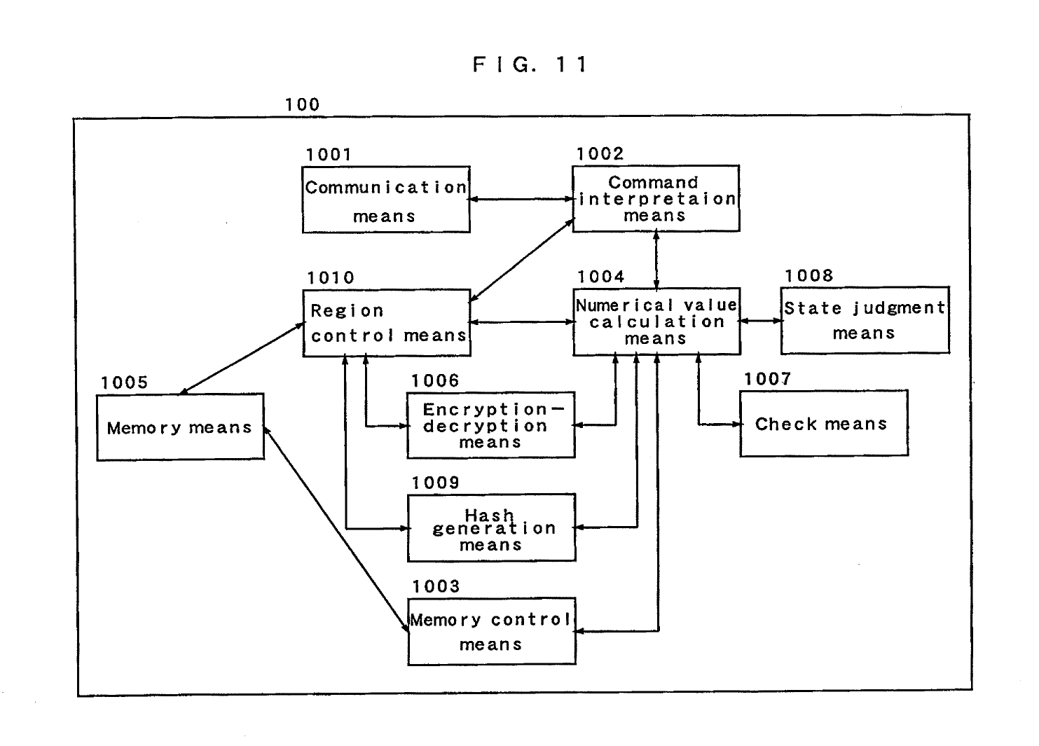

Additionally, in the above-mentioned explanation, a communication path between the external apparatus (200) and the card (100) is not described in detail; however, there is a card (FIG. 11) having two systems, a communication path that can access a memory part at high speed but preliminarily requires area definition (hereinafter referred to as a high-speed communication path) and a communication path that has an access speed inferior to the speed but internally interprets and carries out the area definition (hereinafter referred to as a low-speed communication path).

In the case where the card accepts a plurality of communication methods, it is sometimes required to change the method in the middle of installation. When data of the server is encrypted, the server and the external apparatus cannot see the content and accordingly cannot know the timing for the change. In addition, there is a problem that even if the server preliminarily has the timing for the change as separated plain text information, a card that has not authenticated the external apparatus, in a case where the change is commanded via the external apparatus, cannot trust the command. Hence, a method for adequately and dynamically changing a plurality of the communication methods included in the card even when the above-described download and installation methods are used is provided.

In the management data (H07) whose content is interpreted by the card (100) and that stores data, it is required to write data by using the low-speed communication path; however, the individual data (H02) and the application data (A02) whose contents are interpreted by the card can be written by using a high-speed communication path. Especially in a case where the individual data and the application data have large capacities, the effect is great and an installation time can be reduced. Additionally, in a case where the low-speed communication path and the high-speed communication path are separated, it becomes uncertain whether or not the data has been sent from the normal external apparatus; however, there is no problem about that point because said signature data (A05) and said hash (H05) can secure relevance between two communication paths.

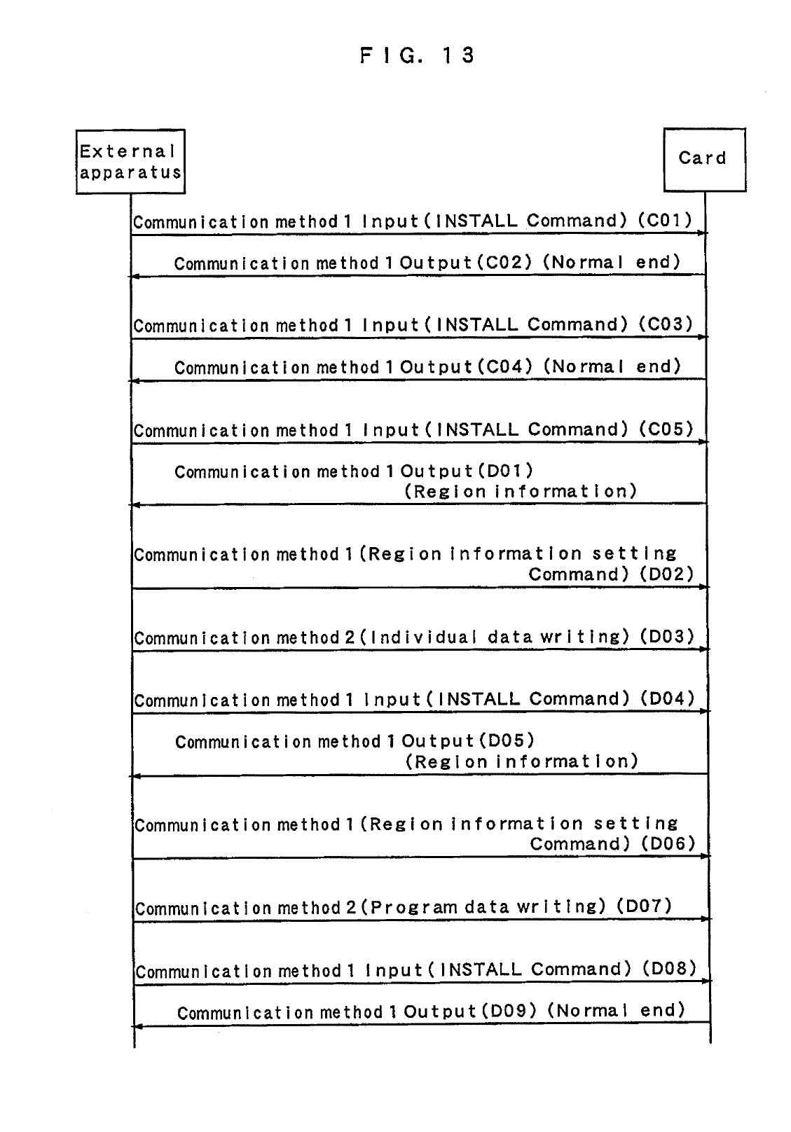

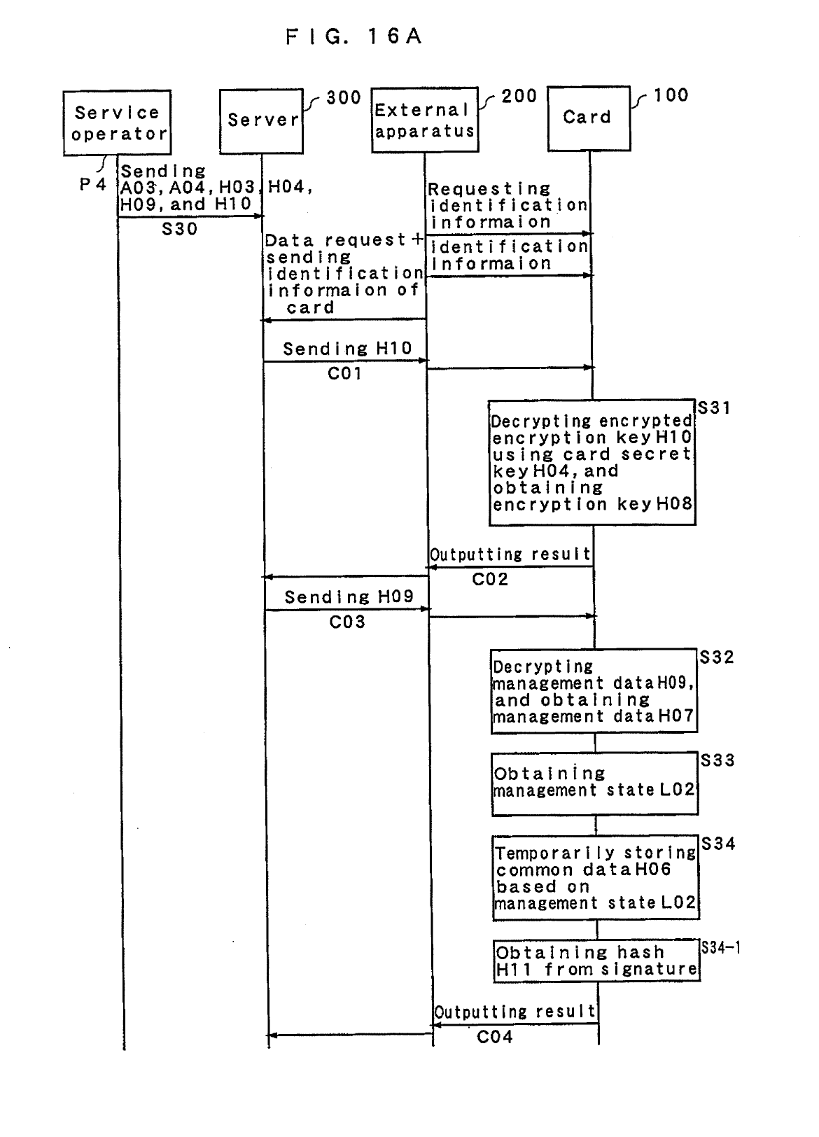

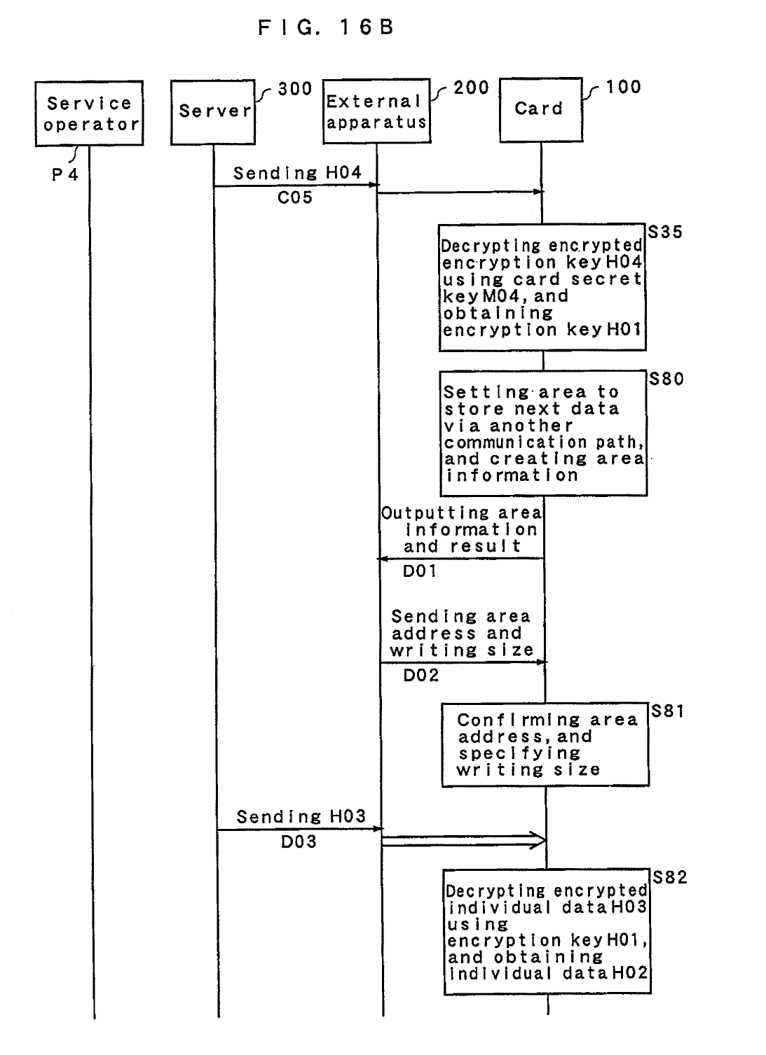

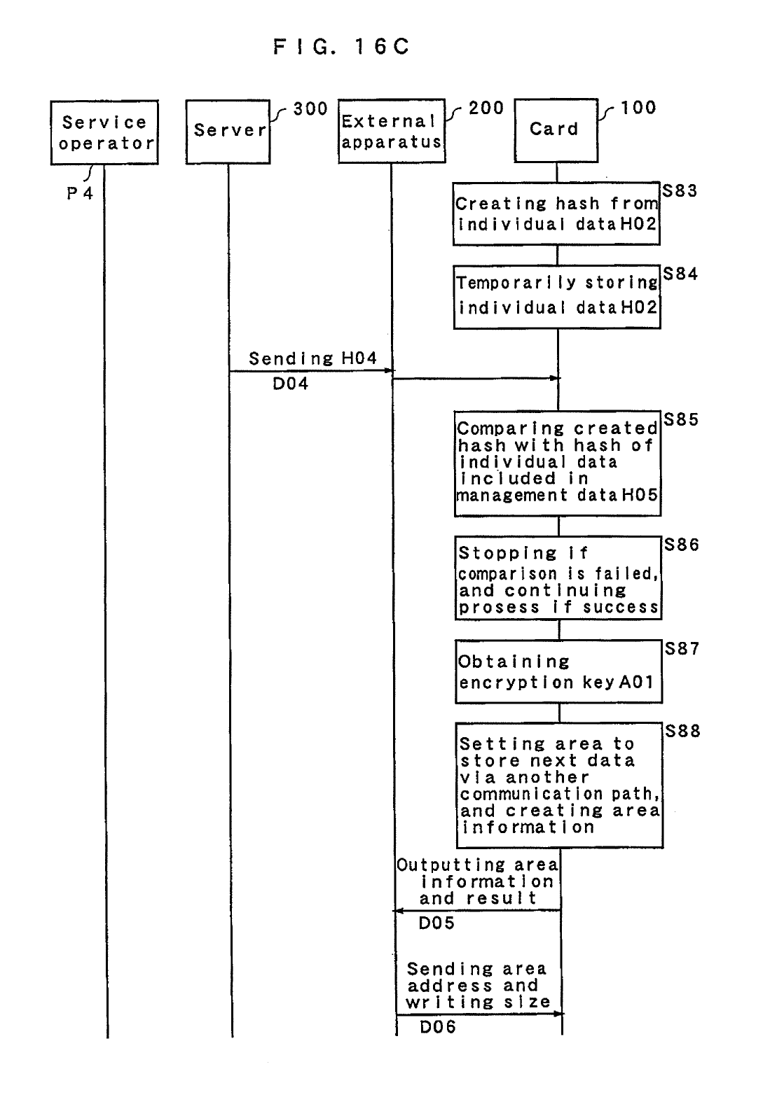

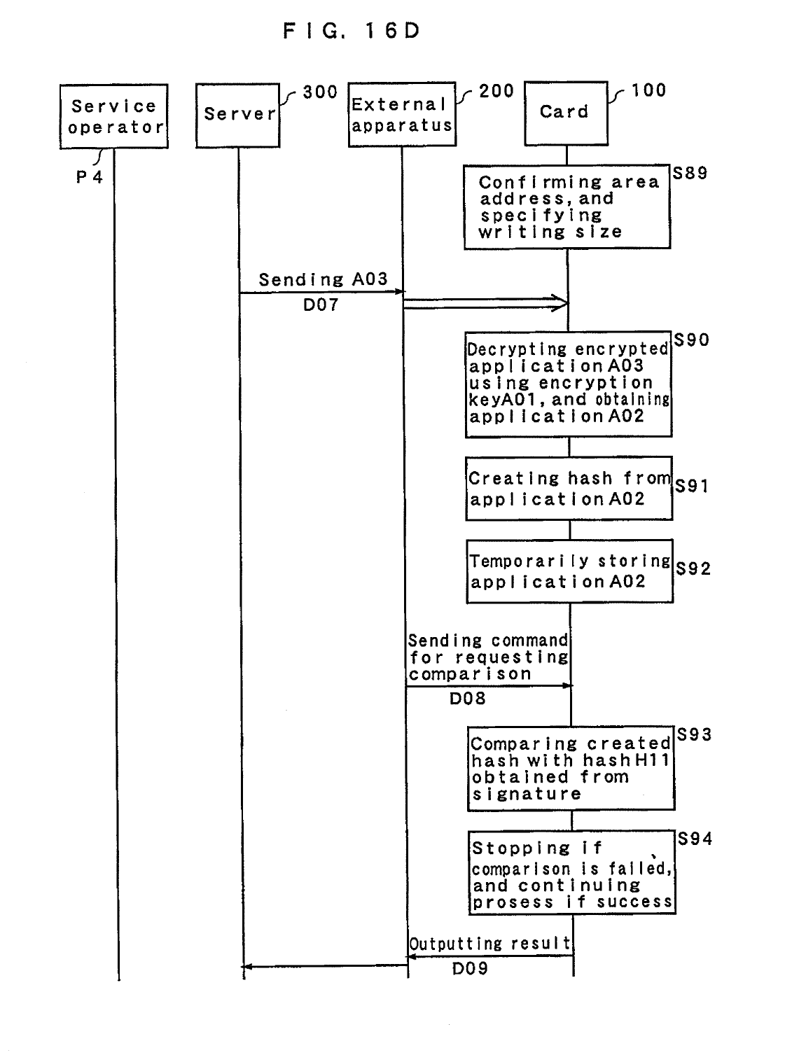

FIG. 13 shows a communication flow between the card (100) and the external apparatus (200) in the case where the card has two communication paths, and referring to FIG. 16A, FIG. 16B, FIG. 16C, and FIG. 16D, the processes carried out by the respective players will be explained.

At first, the communication means (1001) receives data (H10) made by encrypting the management data encryption key via the external apparatus (200), and passes the data to the command interpretation means (1002). The command interpretation means checks a command added to said data, and interprets what the command shows and a purpose of the usage. In the present embodiment, the following operation will be described assuming a content of the command is installation of the application to the card. The command interpretation means (1002) notifies the numerical value calculation means (1004) that the command requests installation of an application, and passes data to the numerical value calculation means. The numerical value calculation means (1004) obtains the card RSA secret key (M04) retained by the memory means (1005) via the memory control means (1003), and decrypts the received data by the encryption-decryption means (1006) (S31). The numerical value calculation means (1004) retains the decrypted management data encryption key (H08) in the memory means (1005) via the memory control means (1003). When there is no problem in said process, a code indicating a normal end is outputted to the external apparatus (200) (C02).

Next, the communication means (1001) receives the encrypted management data (H09) via the external apparatus (200) (C03). The numerical value calculation means (1004) decrypts the management data (H09) encrypted in the encryption-decryption means (1006) by using said management data encryption key (H08) (S32). Since the decrypted management data (H07) conforms with the preliminarily prescribed format (FIG. 9), the numerical value calculation means (1004) reads data in accordance with said format. The application identifier (L01) for identifying an application existing in the common data (H06) included in the management data (H07) is used to read a management state (L02) stored in the memory means (1005) in the card. The application identifier (L01) and the management state (L02) of the application are managed in pairs.

The card obtains the management state (L02) by using the application identifier (L01) (S33). Data required in the received management data varies depending on the management state (L02). Specifically, in the uninstalled state (J01), all of the management data is required, but in the individual data deleted state (J02), only the hash (H05) of the individual data in the management data (H07) is required. In the application deleted state (J03), only the signature (A05) in the management data (H07) is required. When unnecessary data is included in the management data, the data is ignored and the process is not carried out. Thus, there is no problem if the data to be ignored is not sent to the numerical value calculation means (1004) at the time of first sending. On the contrary, when necessary data is not included, the process turns into an error. In that case, the numerical value calculation means (1004) outputs not a normal end but an error code indicating the process finished because of an abnormality of the format in outputting (C04) a result to the external apparatus (200). If no problem, the memory means (1005) temporarily stores data in the common data (H06) required depending on the management state (L02) via the memory control means (1003) (S34). Meanwhile, the process is not limited to the above-mentioned error, and when an abnormal operation has been caused, a code preliminarily-determined with the outside indicating the fact is outputted. In the present embodiment, the state is in the uninstalled state (J01), all of the management data is required.

Based on the state, when the signature (A05) is essential data, the signature is preliminarily decrypted. The numerical value calculation means (1004) decrypts the signature (A05) in the encryption-decryption means (1006) by using the public key (M01) of the manufacturer. The numerical value calculation means (1004) confirms whether or not an adequate padding process is carried out to the decrypted data. In the case where the numerical value calculation means (1004) has confirmed the adequate padding process, a target hash (H11) is obtained because it has been confirmed at least the signature is created by an adequate secret key (S34-1).

In the case where the adequate padding has not been confirmed, the process turns into an error. If there is no problem, the external terminal (200) is notified that the process is normal (C04).

Next, the communication means (1001) receives the data (H04) made by encrypting the individual data encryption key via the external apparatus (200) (C05 in FIG. 16B), and passes the data to the numerical value calculation means (1004). The numerical value calculation means (1004) decrypts the data in the encryption-decryption means (1006) by using the RSA secret key (M04) retained in the memory means (1005) (S35). The memory means (1005) in the card retains the decrypted individual data encryption key (H01). The numerical value calculation means (1004) determines to receive the next individual data by using not the low-speed communication path but the high-speed communication path, obtains address information where the data is expanded from the memory control means (1003), and notifies the area control means (1010) of the address (S80). The numerical value calculation means (1004) notifies the area control means (1010) of the decrypted individual data encryption key (H01). The area control means (1010) retains the received address information, generates an area address and an area size to be disclosed to the outside (hereinafter referred to as area information combining two pieces of said information), the address and size corresponding to the address information, and sends the information to the numerical value calculation means (1004). The numerical value calculation means (1004) outputs said area information to the external apparatus (D01). The area control means (1010) sets the received individual data encryption key (H01) as a decryption key. When not only said area information is notified but also it is sent as an identifier that data required to be sent next is the individual data, the external terminal (200) can efficiently carries out the process and that is preferable.

The external apparatus (200) sends a command for informing an area address for writing and an area size to be written to the card (hereinafter referred to as an area information setting command) by using the received area information and using the high speed communication path (D02). The area size may be smaller than the informed size. The communication means (1001) receives said area information setting command, and sends the data to the command interpretation means (1002). The command interpretation means (1002) interprets said area information setting command, and notifies the area control means of the area address and the size to be written. The area control means (1004) confirms the area address, and sets the size to be written (S81). In a case where the address is different or the size is larger than the preliminarily-informed size, the process becomes an error.

Next, the communication means (1001) receives the encrypted individual data (H03) that is sent by using the high speed communication path (D03). The communication means (1001) passes said data to the command interpretation means. The command interpretation means (1002) sends the received data to the area control means (1010).

The area control means (1010) decrypts the encrypted individual data (H03) in the encryption-decryption means (1006) using said individual data encryption key (H01) (S82), and temporarily stores the decrypted individual data (H02) in the memory means (1005) (S84). Then, in FIG. 16C, the area control means (1010) generates the hash of the individual data (H02) in the hash generation means (1009) (S83).

Next, the communication means (1001) receives the data (A04) made by encrypting an application encryption key via the external apparatus (200) (D04), and passes the data to the numerical value calculation means (1004). The numerical value calculation means (1004) obtains the hash generated by the area control means (1010), and confirms whether or not the hash is the same as the hash (H05) of the individual data included in the management data by using the check means (1007) (S85). In a case of being different, the numerical value calculation means (1004) stops the installation process. When the card outputs a result to the external apparatus (200), an error code indicating not a normal end but that the hash is not identical (S86). The numerical value calculation means (1004) decrypts the data (A04) made by encrypting the application encryption key in the encryption-decryption means (1006) by using the card RSA secret key (M04) retained in the memory means (1005), and obtains the application encryption key (A01) (S87). The card determines to receive the next application data by using not the low-speed communication path but the high-speed communication path, obtains address information where the data is expanded from the memory control means (1003), and notifies the area control means (1010) of the address. The numerical value calculation means (1004) notifies the area control means (1010) of the decrypted application encryption key (A01). The area control means (1010) retains the received address information, generates an area address and an area size to be disclosed to the outside (hereinafter referred to as area information combining two pieces of said information), the address and size corresponding to the address information, and sends the information to the numerical value calculation means (1004). The numerical value calculation means (1004) outputs said area information to the external apparatus (200) (D05). The numerical value calculation means (1004) sets the received application encryption key (A01) as a decryption key. When not only said area information is notified but also it is sent as an identifier that data required to be sent next is the application, the external terminal (200) can efficiently carries out the process and that is preferable.

The external apparatus (200) sends a command for informing an area address for writing and an area size to be written to the card (hereinafter referred to as an area information setting command) by using the received area information and using the high speed communication path (D06). The area size may be smaller than the informed size. The communication means (1001) receives said area information setting command, and sends the data to the command interpretation means (1002). Subsequently, in FIG. 16D, the command interpretation means (1002) interprets said area information setting command, and notifies the area control means (1010) of the area address and the size to be written. The area control means (1010) confirms the area address, and sets the size to be written (S89). In a case where the address is different or the size is larger than the preliminarily-informed size, the process becomes an error.

Next, the communication means (1001) receives the encrypted application data (A03) that is sent by using the high speed communication path (D07). The communication means (1001) passes said data to the command interpretation means (1002). The command interpretation means (1002) sends the received data to the area control means (1010).

The area control means (1010) decrypts the encrypted individual data in the encryption-decryption means (1006) using said application encryption key (A01) (S90). The area control means (1010) generates the hash of the application (A02) in the hash generation means (1009) (S91). The area control means (1010) temporarily stores the decrypted application (A02) in the memory means (1005) (S92).

Next, the communication means (1001) receives a command requesting the check from the external apparatus (200) (D08), and passes the command to the numerical value calculation means (1004). The numerical value calculation means (1004) compares the hash (H11) obtained from the signature with said obtained hash of the application in the check means (1007) (S93). In the case of being different, the numerical value calculation means (1004) stops the installation process. When outputting the result to the external apparatus (200) (D09), the numerical value calculation means (1004) outputs an error code indicating not a normal end but that the hash is not identical. In the case of being identical, the numerical value calculation means (1004) ends the installation process (S94). In the case where the signature is proper, the numerical value calculation means (1004) determines that the hash of the individual data encrypted together with the signature and the common data to be proper, and changes the management state (L02) retained by the memory means (1005) into the installed state (J04) so as to set the common data related to the application, the individual data, and the application to be operable in the card. The numerical value calculation means (1004) outputs a code indicating that the process has normally ended to the external apparatus (200) (D09).

In the present invention, the external apparatus (200) can know timing when the high speed communication path has to be used, a writing-target area, and a size of the target area by using the area information (D01 and D05) added to the output data from the card. The external terminal sends said received area information to the card, and then transfers the area information to be written and the size by using the high speed communication path (D02 and D06). And then, the server writes the data (the individual data and the application data) in the card by using the high speed communication path (D03 and D07).

The external apparatus (200) can judge the number of said communication paths on the basis of the identification information of the card, and when the external apparatus (200) preliminarily knows a type of the encryption data to be sent to the card, the timing can be changed. However, if not obtaining the information from the card, the external apparatus cannot know the area where the data is to be written. Accordingly, when the changing is carried out at the timing of obtaining said area information, another judgment method needs not be used, which is efficient.

Meanwhile, in a method where the application developer (P2) applies for the signature to the card manufacturer (P1), a method for physically, visually, and socially confirming the application developer is beyond the system, and an identity verification method employed by a public institution and a financial institution may be used. In addition, also in a method for delivering the created signature and a method for delivering a development environment distributed from the card manufacturer (P1) to the application developer (P2), a general distributing method is employed and thus the methods are not mentioned. Moreover, it is also possible to apply for a signature, constitute an encryption session between the development environment of the application developer and the manufacturer, and deliver the signature by using the above-mentioned development environment; however, that cannot be realized if the development environment cannot be correctly and safely distributed.

In the present embodiment, the players are separated into three players, the application developer, the service provider, and the server operator; however, their process contents are not limited to forms of the constitution of data to be commonly used, the constitution of data to be individually used, and the delivery of the data.

Meanwhile, the method for generating the hash described in the present invention uses a one-way function, and the function means the SHA-1, the MD5, and the SHA-256 in the conventional technique. A purpose of the use is to summarize a large-sized data and carry out the identification in a small-sized data, and accordingly if said data is already small-sized and there is no need to generate a hash, a value may be directory compared.

Moreover, the signature described in the present embodiment is not described limiting to the case of the public key encryption method, and the signature corresponds to a Message Authentication Code (MAC) if an encryption algorithm is a common key encryption method. Regarding a generation method of the signature, the signature is applied in a secret key after generating the hash in the present embodiment; however, if data is already small-sized, said data may be used as a hash as described in the method for generating said hash.

Furthermore, in the present embodiment, the communication path between the server and the external apparatus is described as the HTTP or the HTTPS; however, the communication path is not limited to them, and if a general method for communication between the server and the external apparatus, whether a wired communication or a wireless communication, is employed, the present invention does not influenced by the method. Accordingly, the server and the external apparatus can uniquely carry out an encryption method and behavior of the card does not change if said encryption communication is carried out.

In the present embodiment, the card (100) is a nonvolatile memory device, the memory means (1005) is a nonvolatile memory, and the remaining communication means (1001), command interpretation means (1002), memory control means (1003), numerical calculation means (1004), encryption-decryption means (1006), check means (1007), and hash generation means (1009) are functions realized by a memory controller.

The external apparatus (200) is an access device for communicating with said nonvolatile memory device, the server (300) is a device for storing data to said nonvolatile memory device, and there is no problem if they are included as memory devices mounted to the access device itself. In this case, both of said access device and said nonvolatile memory device are collectively referred to as a nonvolatile memory system.

### INDUSTRIAL APPLICABILITY

The nonvolatile memory system of the present invention is proposed in order to suppress a storage process for data so as not to be redundant to the nonvolatile memory device, and not to mention a semiconductor memory card, is beneficial in a still image recording/reproducing device, a motion image recording/reproducing device, and a mobile phone that use the nonvolatile memory device such as the semiconductor memory card.

1. A method of recording an application to a memory device, wherein the memory device includes a memory configured to store a secret key, and an interface configured to communicate with an external apparatus in a first communication method and a second communication method that is faster than the first communication method, the method comprising:
decrypting an encrypted management data encryption key by using the secret key, when the interface receives the encrypted management data encryption key in the first communication method from the external apparatus;
decrypting an encrypted management data by using the management data encryption key, when the interface receives the encrypted management data in the first communication method from the external apparatus;
decrypting an encrypted individual data encryption key by using the secret key, when the interface receives the individual data encryption key in the first communication method from the external apparatus;
decrypting an encrypted individual data by using the individual data encryption key, when the interface receives the encrypted individual data in the second communication method from the external apparatus;
recording the decrypted individual data in the memory;
decrypting an encrypted application key by using the secret key, when the interface receives the encrypted application key in the first communication method from the external apparatus;
decrypting an encrypted application by using the application key, when the interface receives the encrypted application in the second communication method from the external apparatus; and
recording the decrypted application in the memory.

2. A memory device comprising:
a memory configured to store a secret key;
an interface configured to communicate with an the external apparatus in a first communication method and a second communication method that is faster than the first communication method; and
a controller configured to control the memory and the interface, wherein the controller is configured to decrypt an encrypted management data encryption key by using the secret key, when the interface receives the encrypted management data encryption key in the first communication method from the external apparatus;
decrypt an encrypted management data by using the management data encryption key, when the interface receives the encrypted management data in the first communication method from the external apparatus;
decrypt an encrypted individual data encryption key by using the secret key, when the interface receives the individual data encryption key in the first communication method from the external apparatus;
decrypt an encrypted individual data by using the individual data encryption key, when the interface receives the encrypted individual data in the second communication method from the external apparatus;
record the decrypted individual data in the memory;
decrypt an encrypted application key by using the secret key, when the interface receives the encrypted application key in the first communication method from the external apparatus;
decrypt an encrypted application by using the application key, when the interface receives the encrypted application in the second communication method from the external apparatus; and
record the decrypted application in the memory.
